(19) United States
(12) Patent Application Publication
(10) Pub. No.: US 2026/0110908 A1
(43) Pub. Date: Apr. 23, 2026

(54) SINGLE NODE FABRICATION OF A MONOLITHIC EYE-PIECE FOR WEARABLE ELECTRONICS APPLICATIONS

(71) Applicant: Meta Platforms Technologies, LLC, Menlo Park, CA (US)

(72) Inventors: Shermin Arab, East Palo Alto, CA (US); Nihar Ranjan Mohanty, Snoqualmie, WA (US); Richard Farrell, Seattle, WA (US)

(21) Appl. No.: 19/364,316

(22) Filed: Oct. 21, 2025

Related U.S. Application Data
(60) Provisional application No. 63/709,861, filed on Oct. 21, 2024.

(51) Int. Cl. G02B 27/01; G02B 6/34

(52) U.S. Cl. CPC G02B 27/0172; G02B 6/34; G02B 2027/0118

(57) ABSTRACT

A device including at least one input grating and at least one output grating disposed over a first surface of a waveguide, at least one active component and corresponding circuitry bonded to the first surface of the waveguide, and at least one lens, mounted to a support structure, that encapsulates both the first surface of the waveguide and a second surface of the waveguide. Corresponding systems and associated methods are also disclosed.

### CROSS REFERENCE TO RELATED APPLICATION

This application claims the benefit of U.S. Provisional Application No. 63/709,861, filed 21 October 2024, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of an exemplary side view of a lens encapsulating a waveguide with active components, according to some embodiments.

FIG. 2 is an illustration of an exemplary side view of a lens encapsulating a waveguide with active components and a film, according to some embodiments.

FIG. 3 is an illustration of an exemplary side view of a lens with an air gap encapsulating a waveguide, according to some embodiments.

FIG. 4A is an illustration of an exemplary top view of a lens with active components disposed over a waveguide, according to some embodiments.

FIG. 4B is an illustration of an exemplary top view of a lens with an antenna disposed over a waveguide, according to some embodiments.

FIG. 5 is an illustration of an exemplary method for a single node fabrication of a lens, according to certain embodiments.

FIG. 6 is a flowchart for an exemplary method for a fabrication of a lens, according to certain embodiments.

FIG. 7 is an illustration of an example artificial-reality system according to some embodiments of this disclosure.

FIG. 8 is an illustration of an example artificial-reality system with a handheld device according to some embodiments of this disclosure.

FIG. 9A is an illustration of example user interactions within an artificial-reality system according to some embodiments of this disclosure.

FIG. 9B is an illustration of example user interactions within an artificial-reality system according to some embodiments of this disclosure.

FIG. 10A is an illustration of example user interactions within an artificial-reality system according to some embodiments of this disclosure.

FIG. 10B is an illustration of example user interactions within an artificial-reality system according to some embodiments of this disclosure.

FIG. 11 is an illustration of an example wrist-wearable device of an artificial-reality system according to some embodiments of this disclosure.

FIG. 12 is an illustration of an example wearable artificial-reality system according to some embodiments of this disclosure.

FIG. 13 is an illustration of an example augmented-reality system according to some embodiments of this disclosure.

FIG. 14A is an illustration of an example virtual-reality system according to some embodiments of this disclosure.

FIG. 14B is an illustration of another perspective of the virtual-reality systems shown in FIG. 14A.

FIG. 15 is a block diagram showing system components of example artificial- and virtual-reality systems.

FIG. 16A is an illustration of an example intermediary processing device according to embodiments of this disclosure.

FIG. 16B is a perspective view of the intermediary processing device shown in FIG. 16A.

FIG. 17 is a block diagram showing example components of the intermediary processing device illustrated in FIG. 16A and 16B.

FIG. 18A is a front view of an example haptic feedback device according to embodiments of this disclosure.

FIG. 18B is a back view of the example haptic feedback device shown in FIG. 22A according to embodiments of this disclosure.

FIG. 19 is a block diagram of example components of a haptic feedback device according to embodiments of this disclosure.

FIG. 20 an illustration of an example system that incorporates an eye-tracking subsystem capable of tracking a user’s eye(s).

FIG. 21 is a more detailed illustration of various aspects of the eye-tracking subsystem illustrated in FIG. 20.

FIG. 22 is an illustration of an example fluidic control system that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Smart glasses often include a number of electronic and other active components, such as antennas, light sources, sensors, etc., positioned within the frame of the smart glasses. Unfortunately, these additional components may make the frame bulky, heavy, uncomfortable to wear, and/or unattractive. In order to decrease the frame’s thickness and/or weight, it may make sense to distribute the weight of these components across a lens of the smart glasses. In this manner, a component-populated lens may be advantageous for applications such as eye and/or face tracking and also help distribute the weight of the components across the smart glasses. However, a functional lens for smart glasses may still involve the assembly of multiple optical components, such as a waveguide, that are mechanically secured together. Therefore, building a monolithic lens that integrates active components onto a waveguide may provide a more structurally robust and reliable optical architecture, while enabling higher scalability and cost-efficient manufacturing.

The present disclosure is generally directed to a single node fabrication of monolithic eyepieces for wearable electronics. For example, a first surface of a waveguide may be patterned to form input and output gratings, and subsequently metalized to enable module bonding of at least one or more active components and corresponding circuitry onto the first surface of the waveguide. In this manner, the need for a separate substrate to house the active components and corresponding circuitry may be eliminated. Instead, the first surface of the waveguide may integrate the input and output gratings and active components without compromising the optical performance of the lens. Additionally, an optical dimming layer may be disposed on a second surface of the waveguide for either active or passive dimming. An ophthalmic lens incorporating a user’s prescription may then subsequently encapsulate the first and second surface of the waveguide, enabling a monolithic architecture that delivers lighter and thinner lenses and improved manufacturability for wearable electronic devices such as augmented-reality (AR) glasses.

Features from any of the embodiments described herein may be used in combination with one another in accordance with the general principles described herein. These and other embodiments, features, and advantages will be more fully understood upon reading the following detailed description in conjunction with the accompanying drawings and claims.

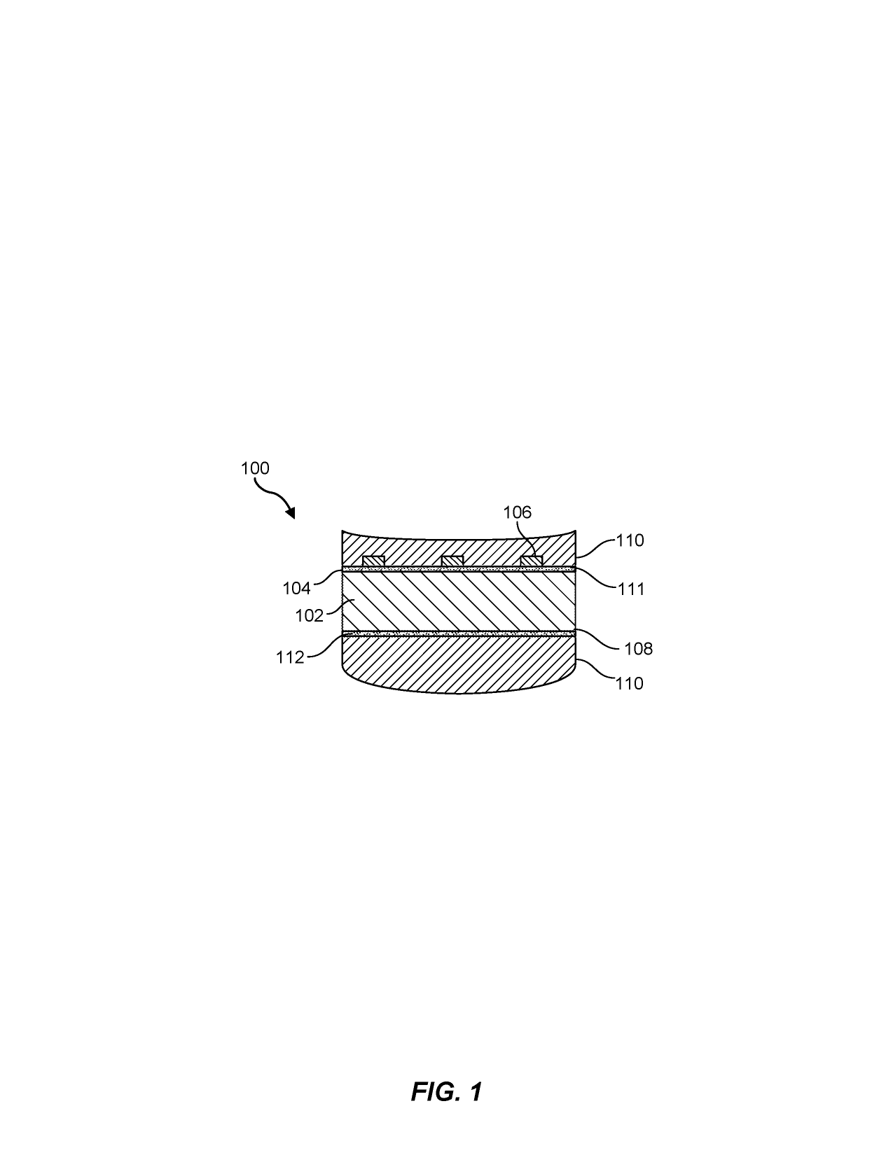

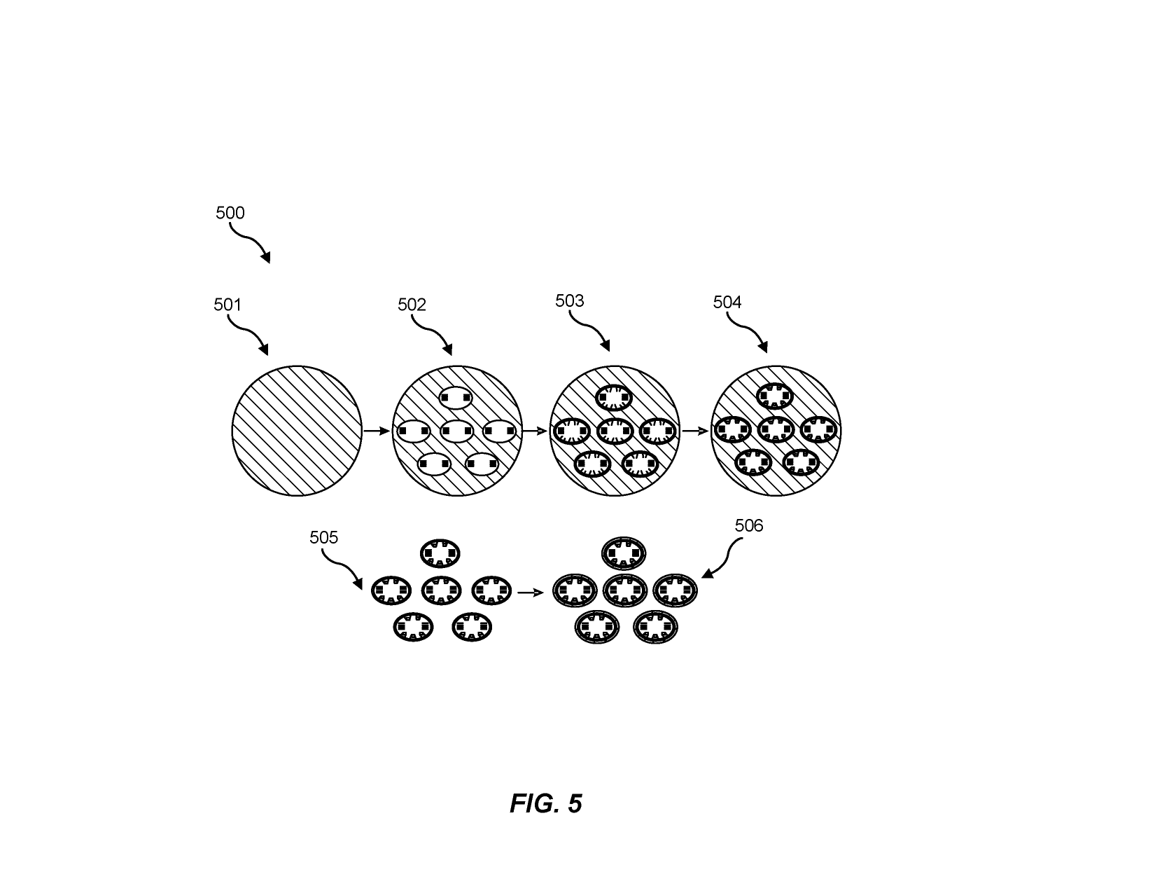

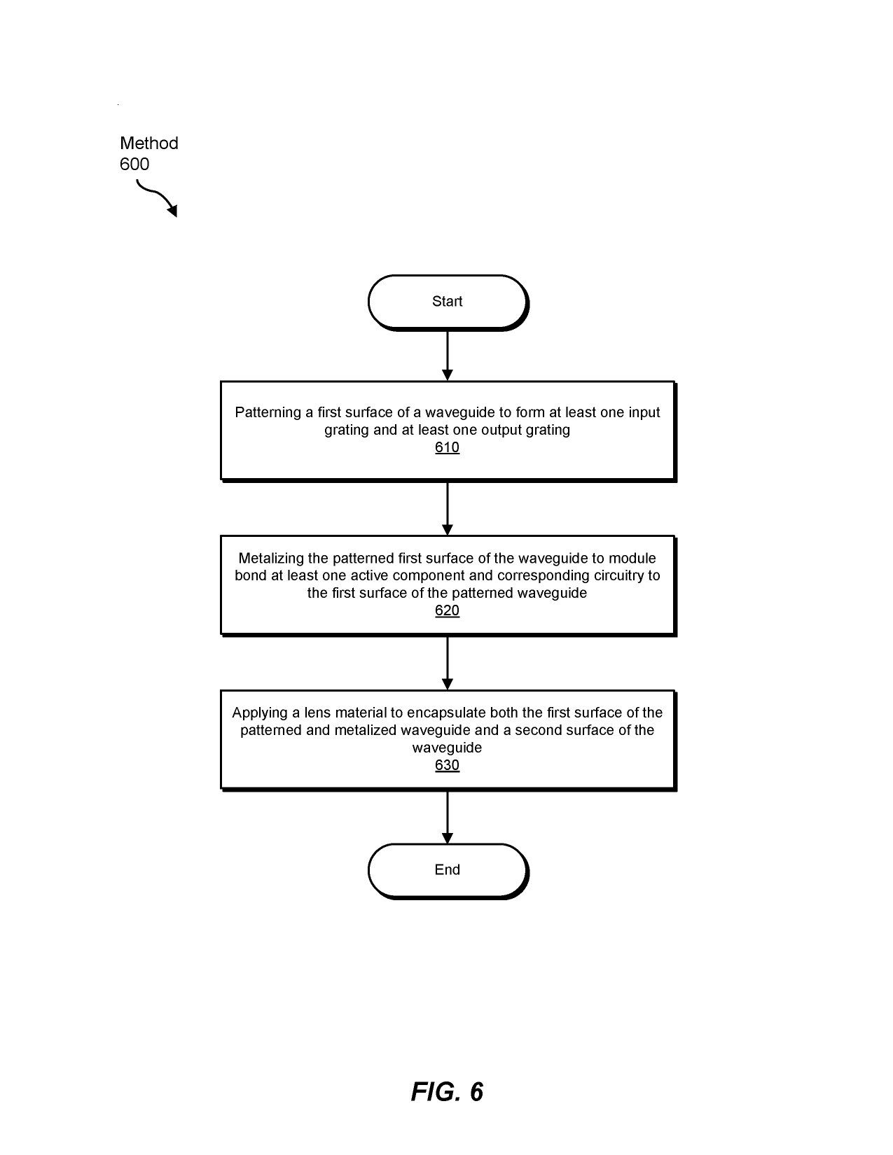

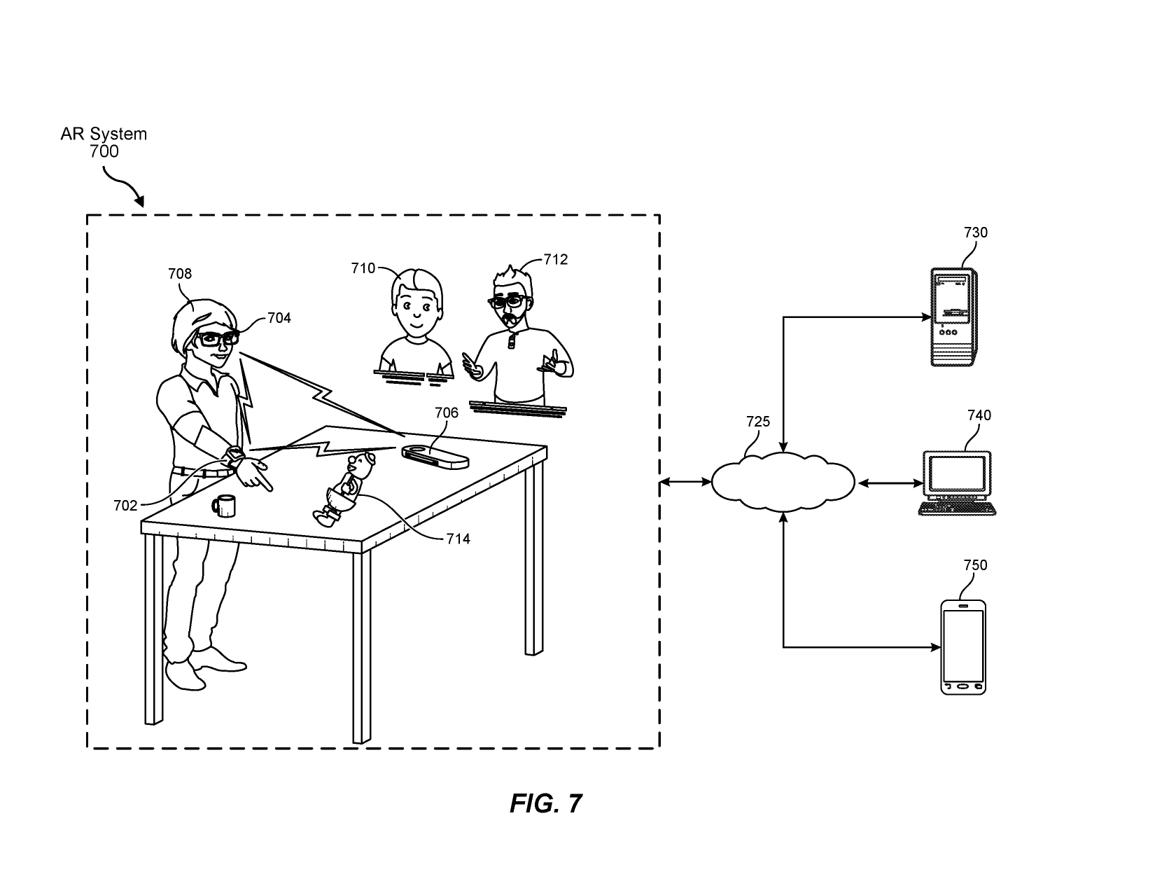

The following will provide, with reference to FIGS. 1-22, detailed descriptions of devices and related methods associated for a lens with integrated circuitry on a waveguide for wearable device electronics. The discussion associated with FIGS. 1-4B include a description of an example side and top view of a lens encapsulating a waveguide with active components. The discussion associated with FIGS. 5-6 describes an example method for a single node fabrication of a lens. The descriptions corresponding to FIGS. 7-22 will provide examples of various systems and devices implementing embodiments presented herein.

Referring to FIG. 1, a side view of an example eyepiece 100 illustrates lens 110 encapsulating a first surface 104 of a waveguide 102 and a second surface 108 of waveguide 102. As used herein, “waveguide” may generally refer to a glass and/or ceramic structure for guiding light from one point to another with minimal loss of energy. In one example, input and output gratings (not shown in FIG. 1) may be patterned onto first surface 104 of waveguide 102, such that the input and output gratings are formed over the first surface 104 of waveguide 102. In other embodiments, the input and output gratings are formed over the second surface 108 of waveguide 102. In some embodiments, the input and output gratings are formed over both the first surface 104 and the second surface 108 of waveguide 102. As used herein, “input gratings” may generally refer to optical structures formed on a waveguide that are configured to couple incident light from an external source into the waveguide by diffraction. As used herein, “output gratings” may generally refer to optical structures formed on a waveguide that are configured to couple guided light propagating within the waveguide, out of the waveguide, and toward a desired target direction. Input and output gratings may direct light into and out of waveguide 102 to form and display a virtual image to a user wearing AR glasses. Typically, one or more active components 106 may require a separate substrate for an eyepiece 100, resulting in user discomfort due to increased lens thickness from multiple stacked lens elements. However, as illustrated in FIG. 1, active components 106 and corresponding circuitry in addition to input and output gratings may be disposed over first surface 104 of waveguide 102.

As used herein, “active components” may generally refer to parts of an electronic circuit that use an external power source to control or modify electrical signals or optical signals. For example, active components 106 may include cameras, sensors, detectors, and light sources such as photodiodes, light emitting diodes (LEDs), etc. Specifically, sensors such as depth sensors and photodetectors may be used for eye-tracking and related optical sensing, while light sources such as LEDs and vertical cavity surface emitting lasers (VCSELs) may be used to generate Lambertian and/or non-Lambertian illumination. In some embodiments, active components 106 may include a surface area of approximately less than 200 µm by approximately less than 200 µm. In some embodiments, a height of active components 106 may be approximately less than 500 µm.

First surface 104 waveguide 102 may be metallized to enable module bonding of active components 106 and corresponding circuitry to the first surface 104 of the waveguide 102. In further embodiments, first surface 104 of waveguide 102 may be patterned with transparent conductors. In these embodiments, active components 106 may require electrical interconnects along the first surface 104 of waveguide 102 to an external power source to provide the necessary voltage and/or current for proper operation. As used herein, “circuitry” may generally refer to an active or passive circuit integrated between active components and the external power source. An external connection opening may include an off-lens driver positioned off of the eyepiece 100, mounted to a support structure such as a frame of the AR glasses, for controlling the voltage and/or current through the circuitry to active components 106.

In some embodiments, circuitry may include interconnecting structures, such as conductive traces and contact pads, for connecting active components 106 to off-lens driver boards. As used herein, “conductive traces” may generally refer to conducting pathways that electrically connect circuitry to active components for enabling current flow. These traces may be made of metal or non-metal materials, such as metal traces that include high conductivity metals (such as Cu, Al, etc.) or non-metal traces that include high conductivity transparent conductors (such as ITO, ZnO, SnO, TiNbO, etc.). As used herein, “contact pads” may generally refer to a connecting point between an active component and corresponding circuitry, or corresponding circuitry and an off-lens driver board. For example, contact pads may include metals such as silver, tin, or aluminum. Accordingly, the metallic surfaces provided by the contact pads enables the secure attachment of active components 106 (e.g., via soldering or bonding), while ensuring effective electrical interfacing with the conductive traces. In some embodiments, a metal stack facilitates the bonding between the traces and contact pads.

Consequently, conductive traces may provide conductive pathways between the active components 106 on the first surface 104 of the waveguide 102 and corresponding circuitry, while a flexible interconnect electrically couples the corresponding circuitry on the first surface 104 of waveguide 102 to the off-lens driver housed in the frame of the AR glasses. In further embodiments, when the conductive traces formed on first surface 104 of the waveguide 102 terminate at the contact pad, the flexible interconnect may electrically couple the circuitry to the off-lens driver boards located in the frame, forming a continuous electric pathway between the active components 106 and off-lens driver boards.

In some embodiments, the conductive traces may be designed to carry continuous current. In addition, the conductive traces may be designed to carry pulsed current. In some embodiments, the conductive traces may be designed to carry currents at less than approximately 50 mA, less than approximately 40 mA, less than approximately 30 mA, or less than approximately 20 mA. In some embodiments, the width of the conductive traces may be approximately less than 25 µm. In some embodiments, the height of the conductive traces may be approximately less than 25 µm. In some embodiments, the conductive traces may be designed to carry continuous current.

Furthermore, the conductive traces may be positioned away from the input and output gratings to allow active components 106, such as LEDs used for eye-tracking illumination, to operate without interfering with an optical region of interest of the waveguide 102. Consequently, active components 106 and corresponding circuitry may be disposed over the patterned and metallized first surface 104 of the waveguide 102, eliminating the need for a separate substrate to house active components 106.

As illustrated in FIG. 1, first surface 104 and second surface 108 may be spaced apart by a thickness of waveguide 102. For example, first surface 104 and second surface 108 may define opposing surfaces of waveguide 102. In one example, first surface 104 and second surface 108 may be parallel to each other, as illustrated in FIG. 1. Furthermore, a first low index optical isolation layer 111 is disposed over first surface 104 of waveguide 102 and a second low index optical isolation layer 112 disposed over a second surface 108 of waveguide. As used herein, “low index optical isolation layer” may generally refer to a low refractive index layer for preventing light leakage to other components or layers in eyepiece 100. For example, first low index optical isolation layer 111 and second low index optical isolation layer 112 may include polymers (e.g., fluorinated polyimides), silica, sol-gels, spin-on glass, or metal-organic-frameworks with low refractive index. In some embodiments, first low index optical isolation layer 111 and second low index optical isolation layer 112 may reduce crosstalk and/or interference between waveguide 102, input and output gratings, and active components 106 and corresponding circuitry.

Lens 110 may encapsulate a first surface 104 and a second surface 108 of a waveguide 102. For example, lens 110 may include meth(acrylics), polyurethane, epoxy and/or other high index polymers. In some embodiments, lens 110 may be designed with an optical power that matches a user’s prescription. In some embodiments, lens 110 may be designed without reference to a user’s prescription. In some embodiments, lens 110 may, for a given thickness, have a transmissivity of approximately 86% to approximately 95%, e.g., approximately 86%, approximately 87%, approximately 88%, approximately 89%, greater than approximately 90%, or greater than approximately 95%. In some embodiments, lens 110 may include a refractive index range of between approximately 1.50 to approximately 1.76, or between approximately 1.55 to approximately 1.76. In some embodiments, lens 110 may include a waviness of approximately less than 0.5 arcmin, approximately less than 0.4 arcmin, or approximately less than 0.1 arcmin.

As used herein, the terms “haze” and “clarity” may refer to an optical phenomenon associated with the transmission of light through a material, and may be attributed, for example, to the refraction of light within the material, e.g., due to secondary phases or porosity and/or the reflection of light from one or more surfaces of the material. For example, lens 110 may include a haze of less than approximately 0.5%, less than approximately 0.4%, less than approximately 0.3%, less than approximately 0.2%, or less than approximately 0.1%. Haze may be associated with an amount of light that is subject to wide angle scattering (i.e., at an angle greater than 2.5° from normal) and a corresponding loss of transmissive contrast, whereas clarity may relate to an amount of light that is subject to narrow angle scattering (i.e., at an angle less than 2.5° from normal) and an attendant loss of optical sharpness or “see-through quality.”

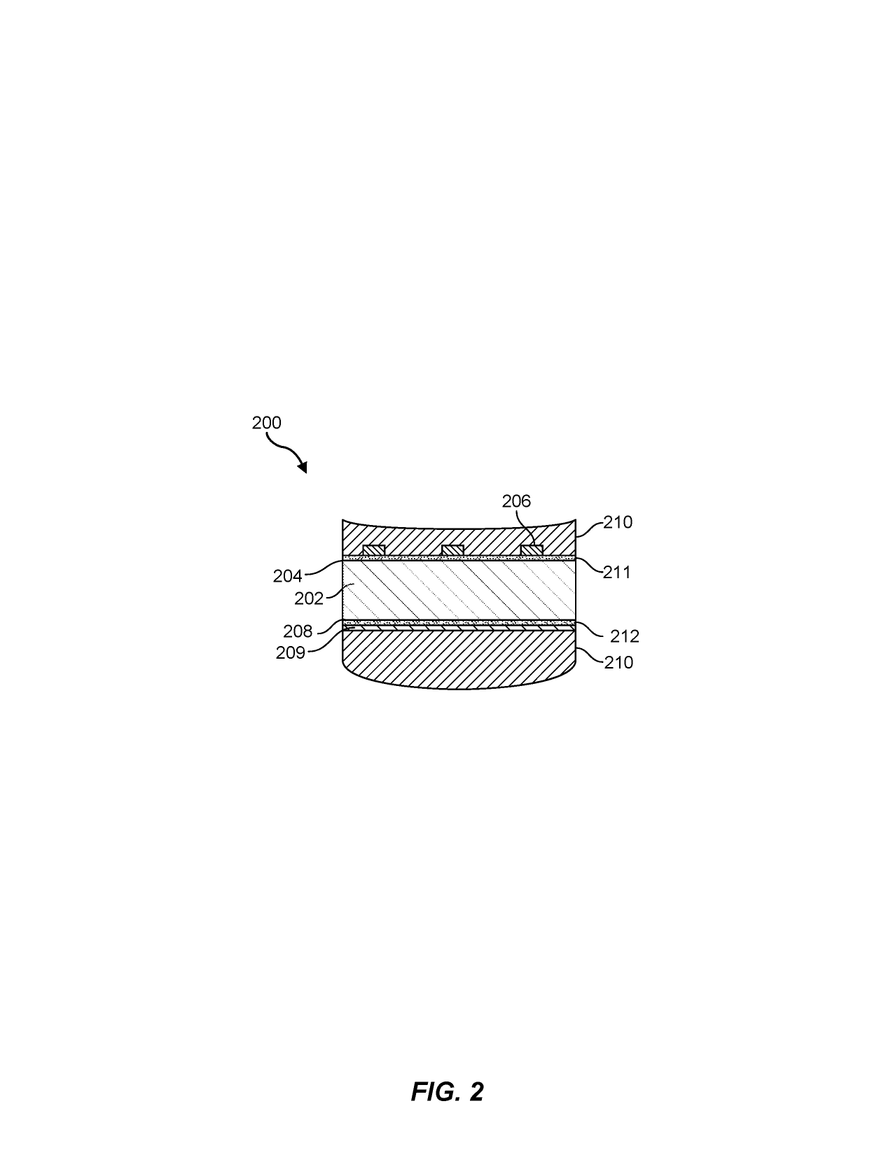

FIG. 2 illustrates a side view of an example eyepiece 200 including lens 210 encapsulating a first surface 204 of waveguide 202 and a second surface 208 of waveguide 202. For example, first surface 204 includes input gratings, output gratings, active components 206 and corresponding circuitry, and a first low optical isolation layer 211. Second surface 208 of waveguide 202 may include a second low optical isolation layer 212 and an optical dimming layer 209. As used herein, “optical dimming layer” may generally refer to a film or coating for selectively transmitting light in response to an external stimulus such as electrical potential, incident light, or temperature.

In some embodiments, optical dimming layer 209 may be used for active dimming of the eyepiece 200. For example, optical dimming layer 209 for active dimming may include one or more electrochromic dyes. In this manner, electrochromic dyes are configured to modulate light transmission in response to an applied voltage where the electrochromic dyes reversibly change optical absorption. In some embodiments, optical dimming layer 209 for active dimming may include reversible metal electrodes that vary reflectivity or transmittance through reversible metal deposition. In some embodiments, optical dimming layer 209 may provide localized active dimming in one or more specific regions of the eyepiece 200. In some embodiments, optical dimming layer 209 may provide global active dimming across the entire eyepiece 200.

In some embodiments, optical dimming layer 209 may be used for passive dimming of the eyepiece 200. For example, optical dimming layer 209 for passive dimming may include one or more photochromic materials for reversible changing optical absorption in response to different light conditions or temperature. In some embodiments, optical dimming layer 209 may provide localized passive dimming in one or more specific regions of the eyepiece 200. In some embodiments, optical dimming layer 209 may provide global passive dimming across the entire eyepiece 200.

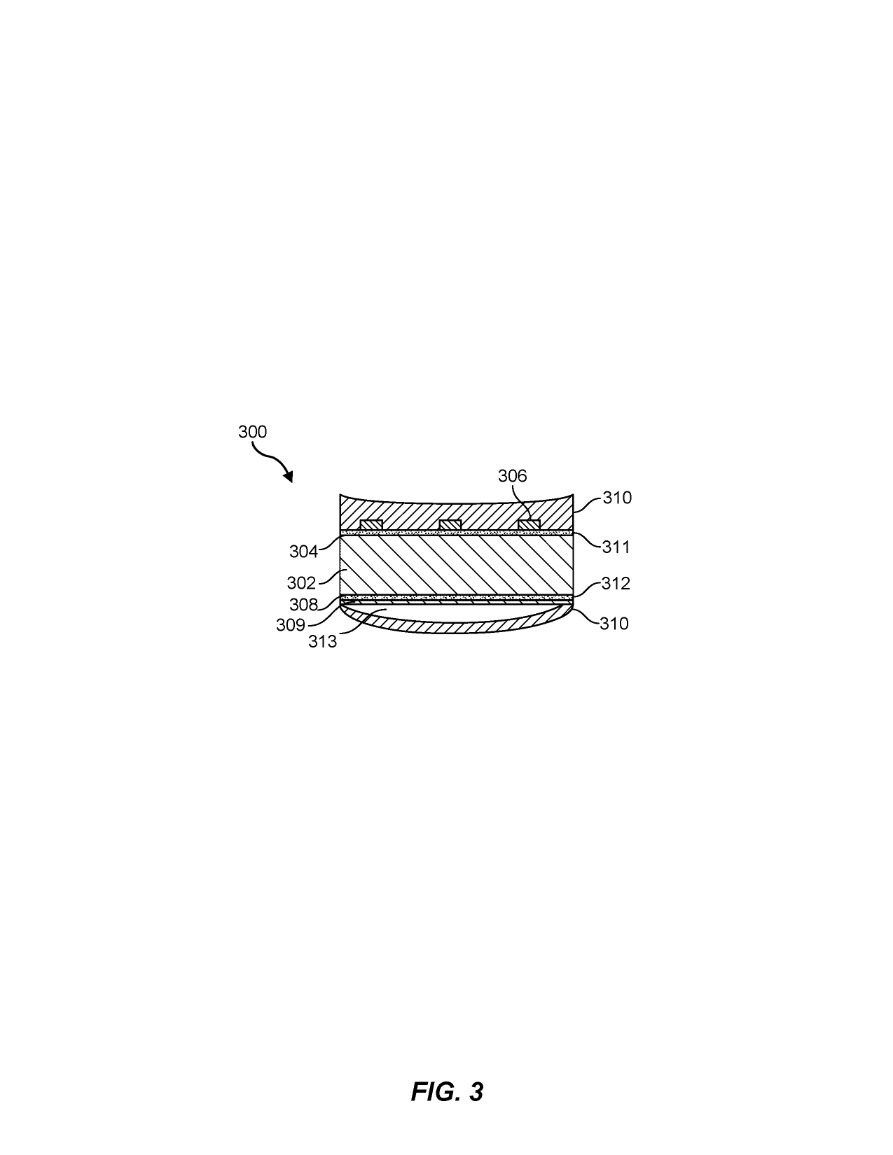

Referring to FIG. 3, a side view of an example eyepiece 300 illustrates a lens 310 including an air gap 313 encapsulating a first surface 304 of a waveguide 302 including input gratings, output gratings, active components 306 and corresponding circuitry, a first low index optical isolation layer 311, and a second surface 308 of a waveguide 302 including a second low index optical isolation layer 312 and an optical dimming layer 309. As illustrated in FIG. 3, air gap 313 may separate lens 310 from waveguide 302. In this manner, air gap 313 may reduce optical interference such as reflection, scattering, or refraction of the waveguide 302 and ensure active components 306 receive accurate signals without distortion.

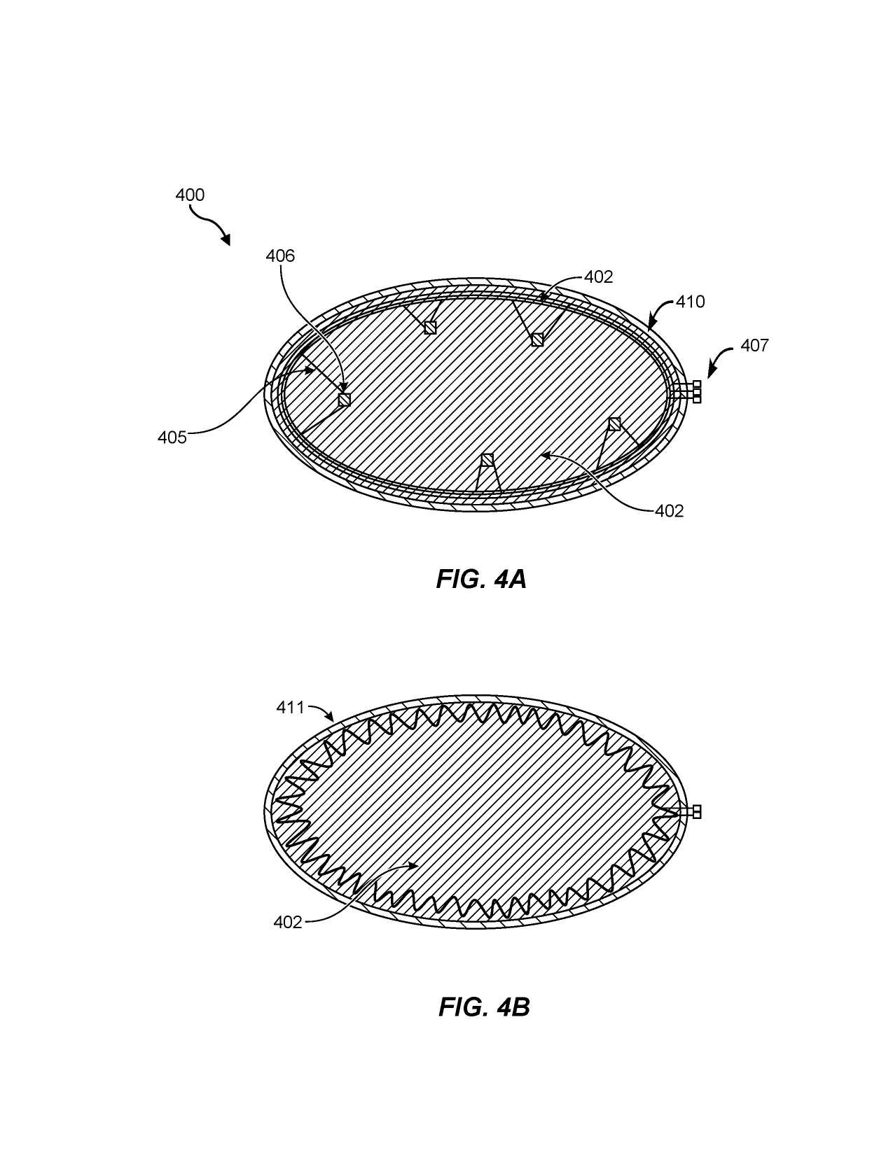

FIGS. 4A and 4B illustrate a top view of example eyepieces 400 including a lens 410 encapsulating a waveguide 402 including active components 406 and corresponding circuitry 405. In some embodiments, an antenna 411 is disposed over waveguide 402, as illustrated in FIG. 4B. For example, antenna 411 disposed over waveguide 402 may be encapsulated by lens 410 in the same manner that active components 406 and corresponding circuitry 405 are encapsulated, as illustrated in FIGS. 1-3. As mentioned previously, an external connection opening 407 may connect the off-lens driver to circuitry 405 on waveguide 402 to facilitate operation of active components 406. As illustrated in FIG. 4A, circuitry 405 including conductive traces may be positioned away from the input and output gratings (not shown in FIG. 4A) to allow active components 406 to operate without interfering with an optical region of interest of the waveguide 402. For example, active components 406 may initially be bonded to circuitry 405 comprising traces. In this manner, both the active components 406 and circuitry 405 may be positioned away from the input and output gratings.

Referring to FIG. 5, method 500 illustrates an example single node fabrication of a lens. For example, step 501 illustrates a sheet of wafer material, which may be formed in a variety of sizes and shapes. In some embodiments, a diameter of the wafer material may be 6 inches. In some embodiments, a diameter of the wafer material may be 8 inches. In some embodiments, a diameter of the wafer material may be 12 inches.

As illustrated in step 502, a first surface of a plurality of regions of the wafer material may be patterned to form at least one input grating and at least one output grating. In one example, a method of patterning may be performed using a nanoimprint lithography with a curable resist and mold to define periodic grating features corresponding to the desired coupling geometry. In another example, a method of patterning may include forming a resist mask defining grating features and subsequently etching the exposed portions of the waveguide.

Step 503 illustrates a process of metalizing the first surface of the plurality of patterned regions with the corresponding circuitry, such as conductive traces. For example, metalizing the waveguide creates conductive features such as the conductive traces by depositing metal films to enable precise electrical and mechanical bonding of the active components. As illustrated in step 503 and as mentioned earlier, the conductive traces may be positioned away from the patterned input and output gratings in step 502. As illustrated in step 502 and step 503, patterning and metalizing the first surface of the plurality of patterned and metalized regions may be performed sequentially on a single production line.

Step 504 illustrates a process of module bonding the active components and corresponding circuitry to the first surface of the plurality of patterned and metalized regions of the wafer material. In some embodiments, module bonding may be performed using a die-to-wafer process. For example, each of the desired active components, such as an LED, sensors, etc., may be precisely aligned and bonded to the wafer material. In some embodiments, module bonding may include flip-chip bonding via a metal-to-metal interface. For example, each active component may be flipped such that the contact pads of the active component align and bond to the corresponding conductive trace on the wafer substrate.

Step 505 illustrates a process of separating the first surfaces of the plurality of patterned and metalized regions of the wafer material. As illustrated in step 505, the excess wafer material may be removed in the separation of the plurality of patterned and metalized regions to create an eye shape for an eyepiece of a wearable electronic, such as AR glasses. For example, the separation of the patterned and metalized regions from the sheet of wafer material may include dicing, laser cutting and/or scribing, stealth diving, or cleaving.

Step 506 illustrates a lens material encapsulating each individually separated, patterned and metallized region. As mentioned earlier, the lens material may include an optical power that is based on a user’s prescription and encapsulate the separated, patterned, and metallized region such that no extra stress and/or damage is applied to the active components and corresponding circuitry. However, in some embodiments, the wafer material may be the required size for patterning and does not require separation.

FIG. 6 is a flowchart of an exemplary method 600 for a fabrication of a lens. Step 610 includes patterning a first surface of a waveguide to form at least one input grating and at least one output grating. As mentioned earlier, a method of patterning may be performed using a nano-imprint lithography process with a curable resist and mold or forming a resist mask for defining gratings and etching the exposed portions of the waveguide.

Step 620 includes metalizing the first surface of the patterned waveguide to module bond at least one active component and corresponding circuitry to the first surface of the patterned waveguide, where the active components and corresponding circuitry including conductive traces are positioned away from the input and output gratings. For example, metalizing the waveguide may include depositing metal films to create conductive traces using metal materials for precise electrical and mechanical bonding of the active components. In some embodiments, metalizing the waveguide may include depositing non-metal materials including high conductivity transparent conductors. In this manner, the active components and corresponding circuitry may not obstruct the optical region of the waveguide, including the input and output gratings. As mentioned earlier, module bonding may be implemented using flip-chip bonding via a metal-to-metal interface, in which contact pads of the active components are inverted and aligned with corresponding conductive traces on the waveguide, allowing each contact pad to bond directly to its respective trace.

Step 630 includes applying a lens material to encapsulate both the first surface of the patterned and metalized waveguide and a second surface of the waveguide. For example, during the encapsulation of the waveguide, the lens material may be applied such that it uniformly covers the first surface of the patterned and metalized waveguide and the second surface of the waveguide. In some embodiments, as described earlier, an optical dimming layer may be included for passive or active dimming and also be encapsulated by the lens material.

As described above, the disclosed devices and methods may enable a monolithic lens for wearable electronics. In some embodiments, the disclosed methods may employ sequential patterning and metalizing of a first surface of a waveguide on a single production line to achieve thinner and lighter eyepieces without obstructing an operation of a waveguide. In some embodiments, an optical dimming layer for either active or passive dimming may be included in the monolithic lens. In this manner, the disclosed devices and methods may achieve improved scalability and a reduced manufacturing cost for eyepieces of wearable electronics, such as AR glasses.

### Example Embodiments

Example 1: A device including at least one input grating and at least one output grating disposed over a first surface of a waveguide, at least one active component and corresponding circuitry bonded to the first surface of the waveguide, and at least one lens, mounted to a support structure, that encapsulates both the first surface of the waveguide and a second surface of the waveguide.

Example 2: The device of Example 1, where the first surface of the waveguide is sequentially patterned to form the at least one input grating and the at least one output grating and metallized to bond the at least one active component and corresponding circuitry to the patterned first surface of the waveguide.

Example 3: The device of any of Examples 1-2, where the first surface of the waveguide is spaced apart from the second surface of the waveguide by a thickness of the waveguide.

Example 4: The device of any of Examples 1-3, where the at least one active component and corresponding circuitry comprise conductive traces positioned away from the at least one input grating and the at least one output grating.

Example 5: The device of any of Examples 1-4, where the conductive traces are configured to connect the at least one active component to off-lens driver boards.

Example 6: The device of any of Examples 1-5, where the conductive traces comprise a material selected from the group consisting of metals and non-metals.

Example 7: The device of any of Examples 1-6, further including an optical dimming layer disposed over the second surface of the waveguide.

Example 8: The device of any of Examples 1-7, where the optical dimming layer comprises at least one electrochromic dye configured to provide active dimming.

Example 9: The device of any of Examples 1-8, where the optical dimming layer comprises at least one photochromatic material configured to provide passive dimming.

Example 10: The device of any of Examples 1-9, where the lens comprises a material selected from the group consisting of meth(acrylics), polyurethane, epoxy and other high index polymers.

Example 11: A method including patterning a first surface of a waveguide to form at least one input grating and at least one output grating, metalizing the first surface of the patterned waveguide to module bond at least one active component and corresponding circuitry to the first surface of the patterned waveguide, and applying a lens material to encapsulate both the first surface of the patterned and metalized waveguide and a second surface of the waveguide.

Example 12: The method of Example 11, where patterning and metalizing the first surface of the waveguide is performed sequentially on a single production line.

Example 13: The method of Examples 11-12, where the first surface of the waveguide is spaced apart from the second surface of the waveguide by a thickness of the waveguide.

Example 14: The method of Examples 11-13, where the at least one active component and corresponding circuitry are positioned away from the at least one input grating and the at least one output grating.

Example 15: The method of any of Examples 11-14, further including disposing an optical dimming layer over a second surface of the waveguide.

Example 16: The method of any of Examples 11-15, where the optical dimming layer comprises at least one electrochromic dye configured to provide active dimming.

Example 17: The method of any of Examples 11-16, where the optical dimming layer comprises at least one photochromatic material configured to provide passive dimming.

Example 18: The method of any of Examples 11-17, further including applying the lens material uniformly to cover the first surface of the waveguide and a second surface of the waveguide the waveguide.

Example 19: A method including (i) patterning a first surface of a plurality of regions of a wafer material to form at least one input grating and at least one output grating, (ii) metallizing the first surface of the plurality of patterned regions of the wafer material to module bond at least one active component and corresponding circuitry to the first surface of the plurality of patterned regions of the wafer material, (iii) separating the first surface of the plurality of patterned and metalized regions of the wafer material, and (iv) applying a lens material to encapsulate the first surface of the plurality of patterned and metalized regions of the wafer material and a second surface of the wafer material.

Example 20: The method of Example 19, where sequentially encapsulating multiple materials individually creates a gradient refractive index lens.

Embodiments of the present disclosure may include or be implemented in conjunction with various types of Artificial-Reality (AR) systems. AR may be any superimposed functionality and/or sensory-detectable content presented by an artificial-reality system within a user’s physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

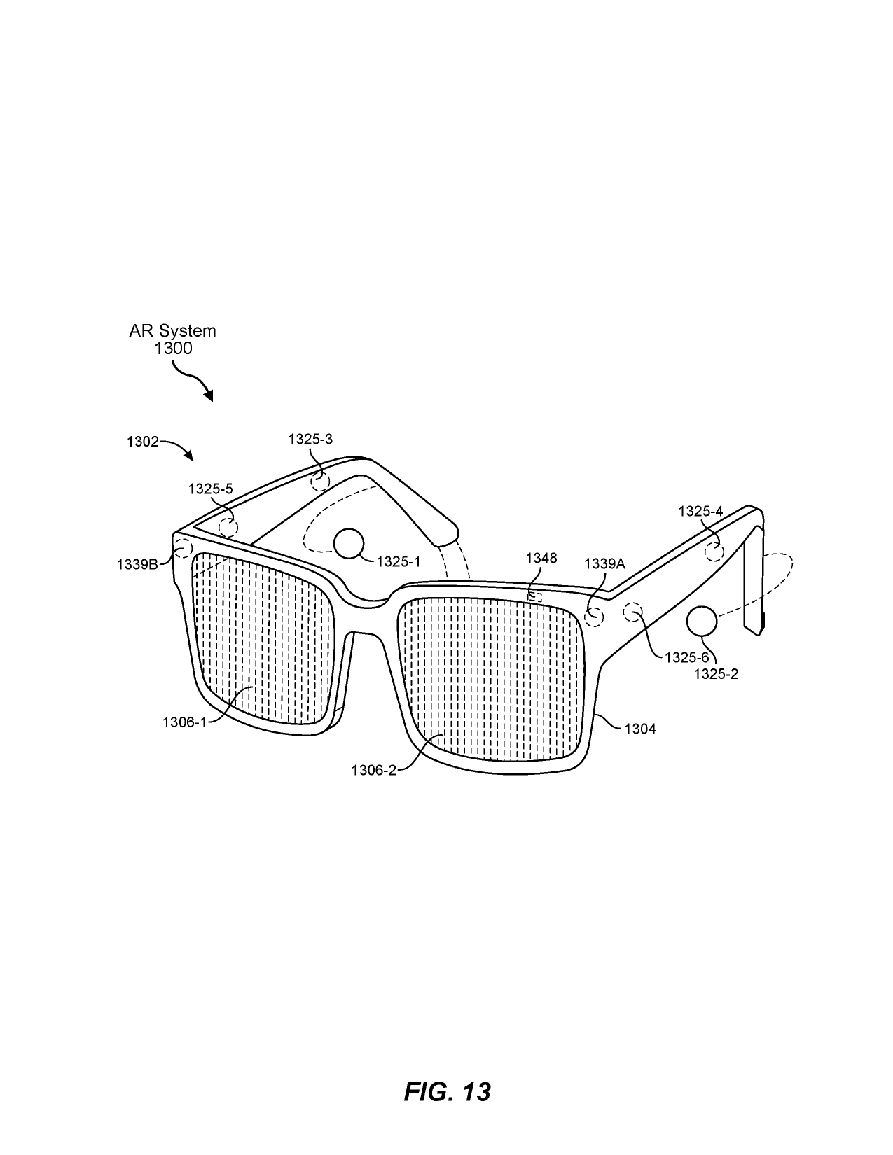

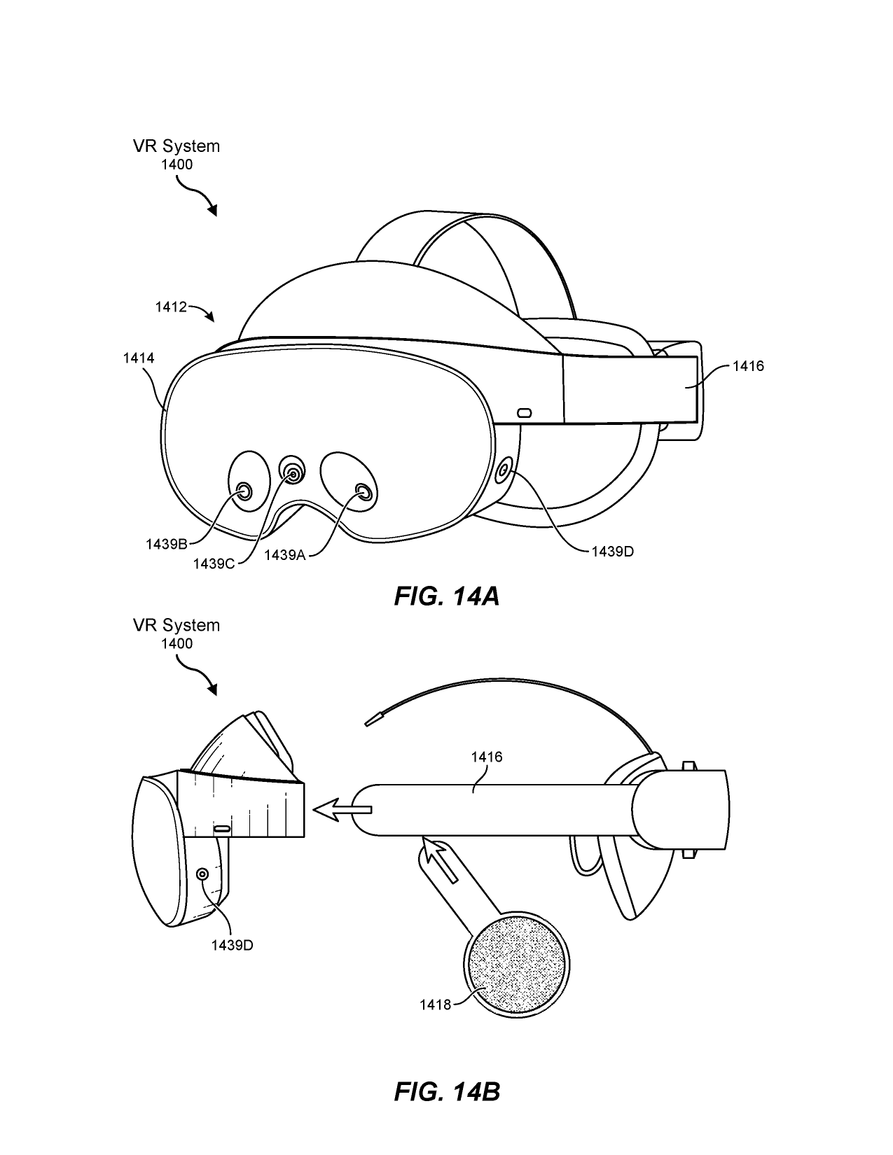

AR systems may be implemented in a variety of different form factors and configurations. Some AR systems may be designed to work without near-eye displays (NEDs). Other AR systems may include a NED that also provides visibility into the real world (such as, e.g., augmented-reality system 1300 in FIG. 13) or that visually immerses a user in an artificial reality (such as, e.g., virtual-reality system 1400 in FIGS. 14A and 14B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

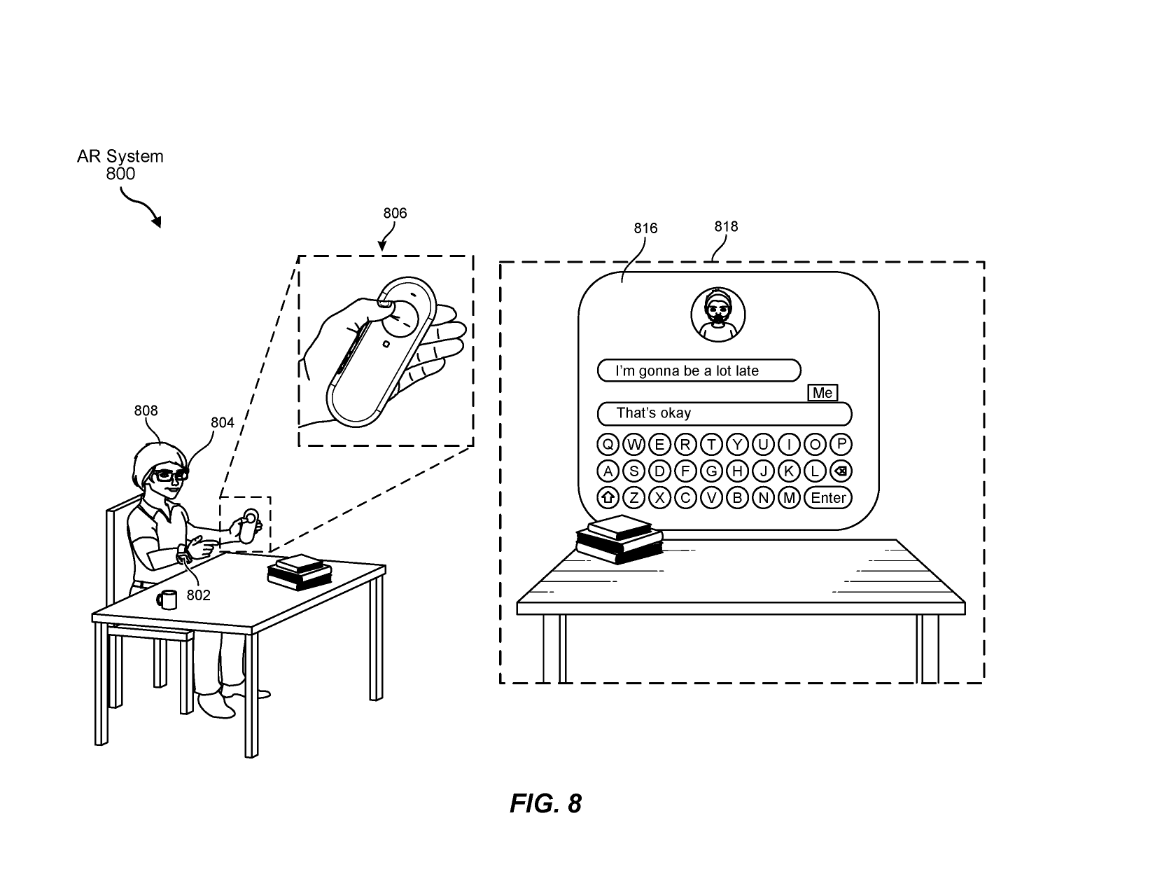

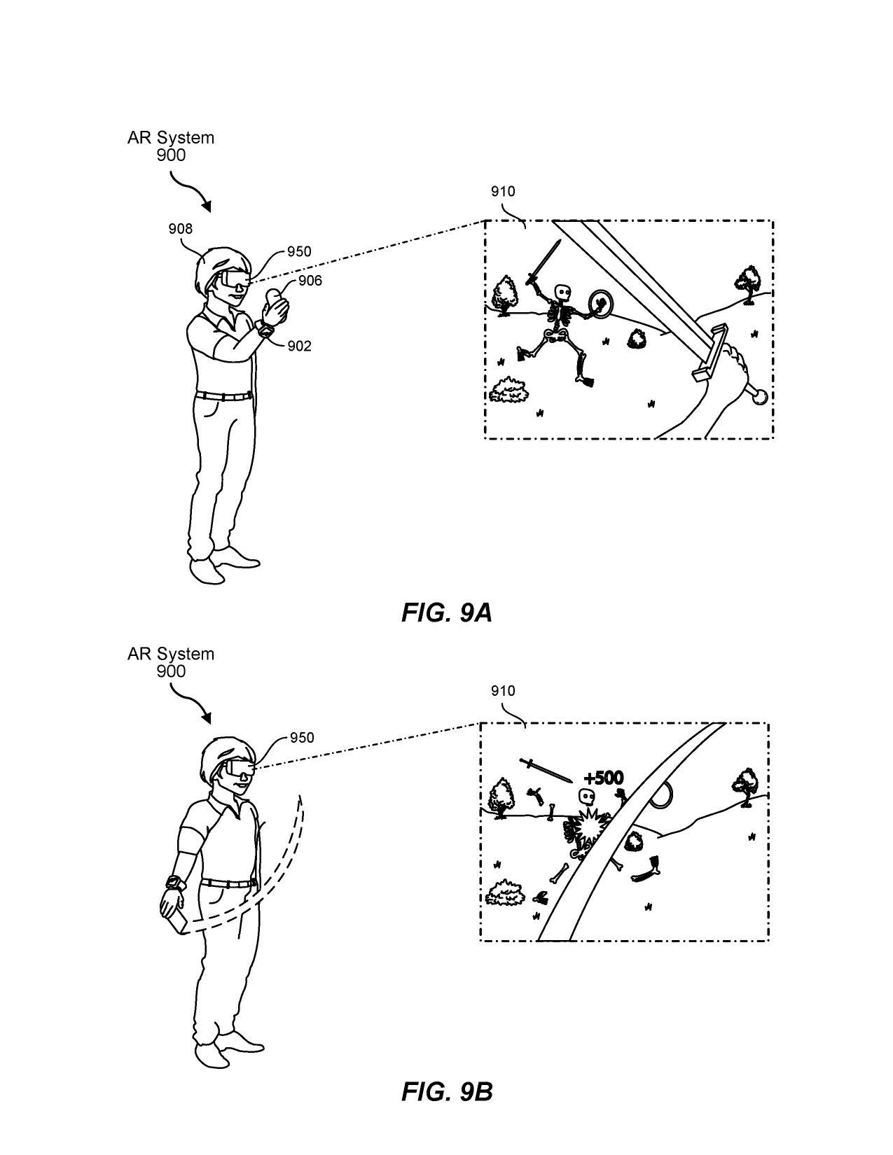

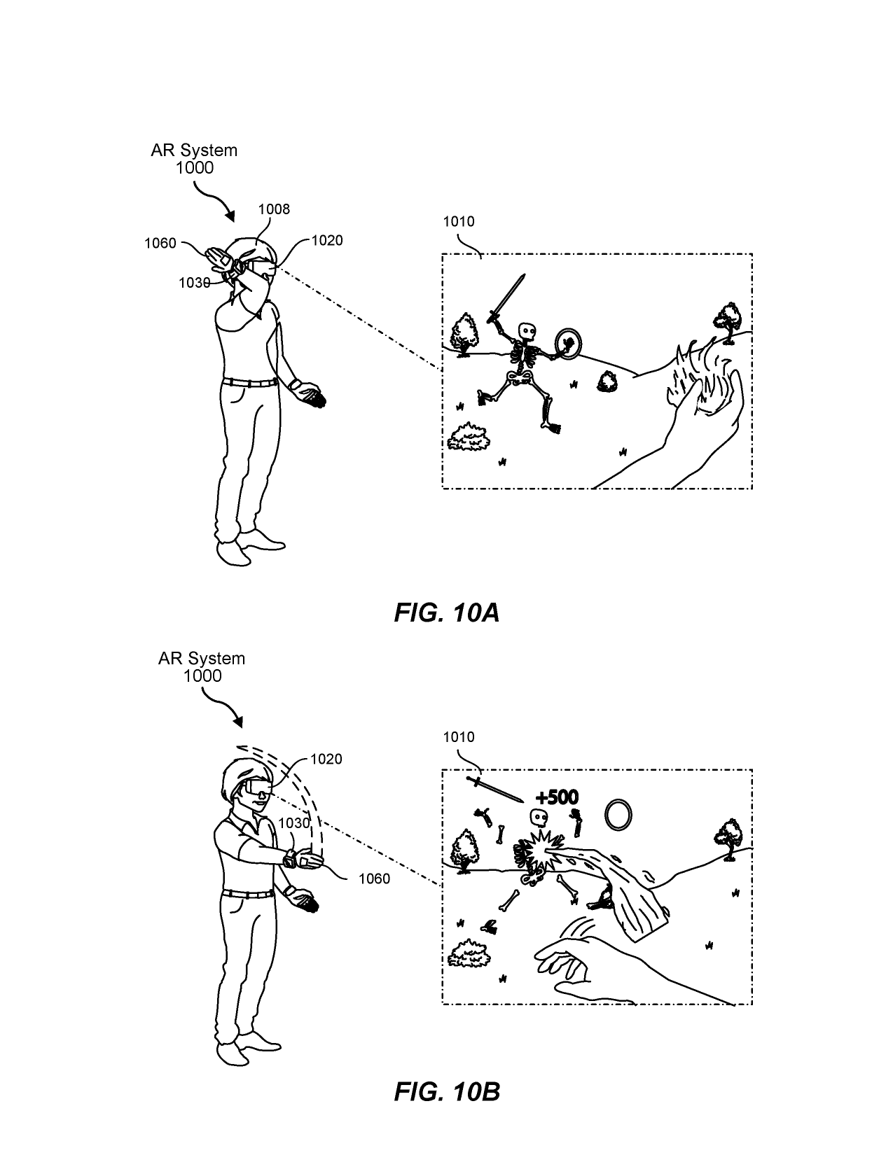

FIGS. 7-10B illustrate example artificial-reality (AR) systems in accordance with some embodiments. FIG. 7 shows a first AR system 700 and first example user interactions using a wrist-wearable device 702, a head-wearable device (e.g., AR glasses 1300), and/or a handheld intermediary processing device (HIPD) 706. FIG. 8 shows a second AR system 800 and second example user interactions using a wrist-wearable device 802, AR glasses 804, and/or an HIPD 806. FIGS. 9A and 9B show a third AR system 900 and third example user 908 interactions using a wrist-wearable device 902, a head-wearable device (e.g., VR headset 950), and/or an HIPD 906. FIGS. 10A and 10B show a fourth AR system 1000 and fourth example user 1008 interactions using a wrist-wearable device 1030, VR headset 1020, and/or a haptic device 1060 (e.g., wearable gloves).

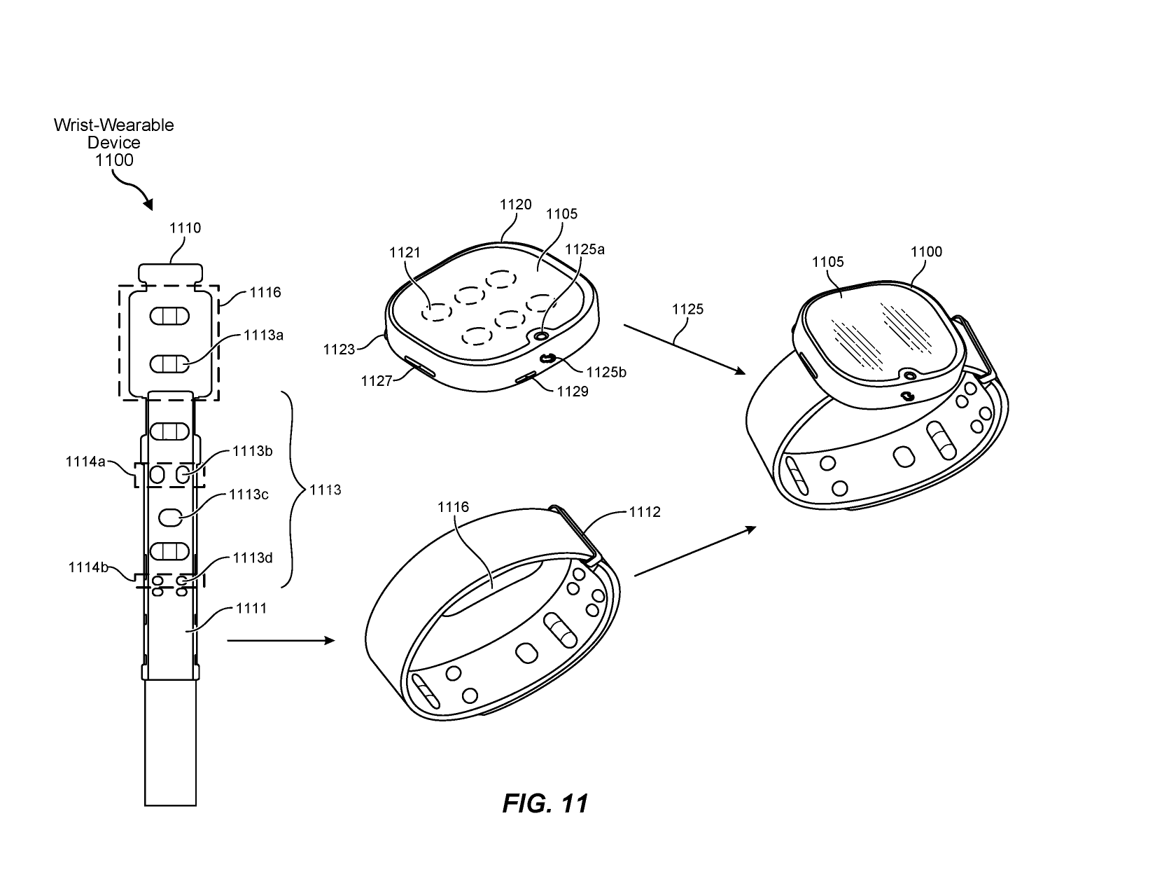

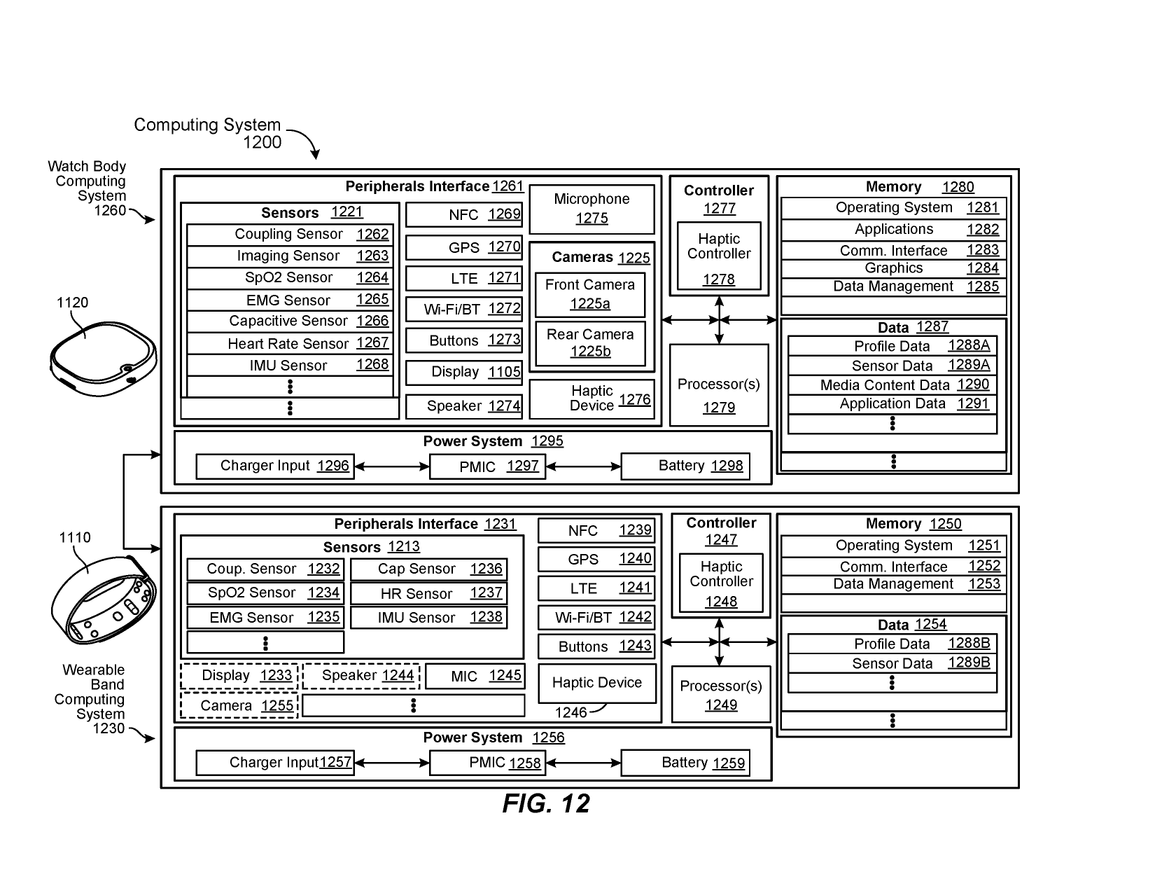

A wrist-wearable device 1100, which can be used for wrist-wearable device 702, 802, 902, 1030, and one or more of its components, are described below in reference to FIGS. 11 and 12; head-wearable devices 1300 and 1400, which can respectively be used for AR glasses 704, 804 or VR headset 950, 1020, and their one or more components are described below in reference to FIGS. 13-15.

Referring to FIG. 7, wrist-wearable device 702, AR glasses 704, and/or HIPD 706 can communicatively couple via a network 725 (e.g., cellular, near field, Wi-Fi, personal area network, wireless LAN, etc.). Additionally, wrist-wearable device 702, AR glasses 704, and/or HIPD 706 can also communicatively couple with one or more servers 730, computers 740 (e.g., laptops, computers, etc.), mobile devices 750 (e.g., smartphones, tablets, etc.), and/or other electronic devices via network 725 (e.g., cellular, near field, Wi-Fi, personal area network, wireless LAN, etc.).

In FIG. 7, a user 708 is shown wearing wrist-wearable device 702 and AR glasses 704 and having HIPD 706 on their desk. The wrist-wearable device 702, AR glasses 704, and HIPD 706 facilitate user interaction with an AR environment. In particular, as shown by first AR system 700, wrist-wearable device 702, AR glasses 704, and/or HIPD 706 cause presentation of one or more avatars 710, digital representations of contacts 712, and virtual objects 714. As discussed below, user 708 can interact with one or more avatars 710, digital representations of contacts 712, and virtual objects 714 via wrist-wearable device 702, AR glasses 704, and/or HIPD 706.

User 708 can use any of wrist-wearable device 702, AR glasses 704, and/or HIPD 706 to provide user inputs. For example, user 708 can perform one or more hand gestures that are detected by wrist-wearable device 702 (e.g., using one or more EMG sensors and/or IMUs, described below in reference to FIGS. 11 and 12) and/or AR glasses 704 (e.g., using one or more image sensor or camera, described below in reference to FIGS. 13-10) to provide a user input. Alternatively, or additionally, user 708 can provide a user input via one or more touch surfaces of wrist-wearable device 702, AR glasses 704, HIPD 706, and/or voice commands captured by a microphone of wrist-wearable device 702, AR glasses 704, and/or HIPD 706. In some embodiments, wrist-wearable device 702, AR glasses 704, and/or HIPD 706 include a digital assistant to help user 708 in providing a user input (e.g., completing a sequence of operations, suggesting different operations or commands, providing reminders, confirming a command, etc.). In some embodiments, user 708 can provide a user input via one or more facial gestures and/or facial expressions. For example, cameras of wrist-wearable device 702, AR glasses 704, and/or HIPD 706 can track eyes of user 708 for navigating a user interface.

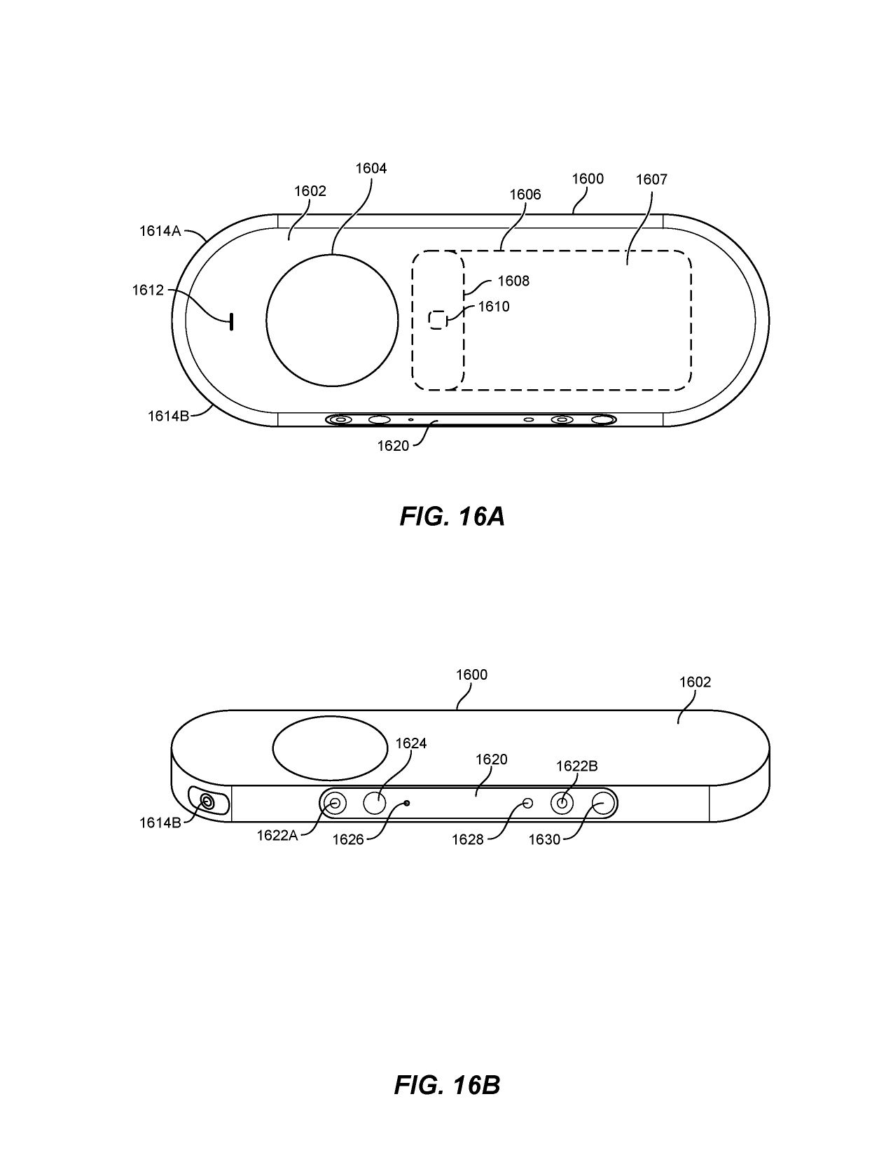

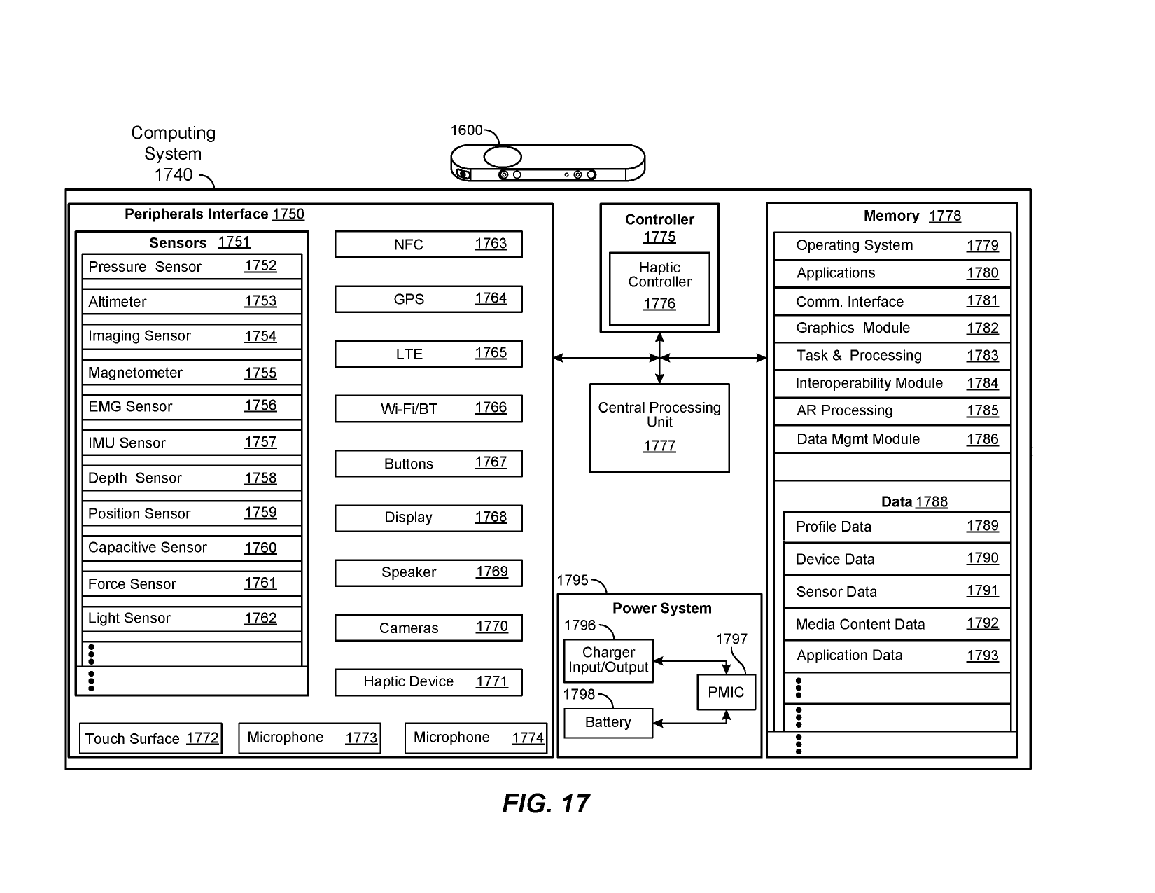

Wrist-wearable device 702, AR glasses 704, and/or HIPD 706 can operate alone or in conjunction to allow user 708 to interact with the AR environment. In some embodiments, HIPD 706 is configured to operate as a central hub or control center for the wrist-wearable device 702, AR glasses 704, and/or another communicatively coupled device. For example, user 708 can provide an input to interact with the AR environment at any of wrist-wearable device 702, AR glasses 704, and/or HIPD 706, and HIPD 706 can identify one or more back-end and front-end tasks to cause the performance of the requested interaction and distribute instructions to cause the performance of the one or more back-end and front-end tasks at wrist-wearable device 702, AR glasses 704, and/or HIPD 706. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIGS. 16-17, HIPD 706 can perform the back-end tasks and provide wrist-wearable device 702 and/or AR glasses 704 operational data corresponding to the performed back-end tasks such that wrist-wearable device 702 and/or AR glasses 704 can perform the front-end tasks. In this way, HIPD 706, which has more computational resources and greater thermal headroom than wrist-wearable device 702 and/or AR glasses 704, performs computationally intensive tasks and reduces the computer resource utilization and/or power usage of wrist-wearable device 702 and/or AR glasses 704.

In the example shown by first AR system 700, HIPD 706 identifies one or more back-end tasks and front-end tasks associated with a user request to initiate an AR video call with one or more other users (represented by avatar 710 and the digital representation of contact 712) and distributes instructions to cause the performance of the one or more back-end tasks and front-end tasks. In particular, HIPD 706 performs back-end tasks for processing and/or rendering image data (and other data) associated with the AR video call and provides operational data associated with the performed back-end tasks to AR glasses 704 such that the AR glasses 704 perform front-end tasks for presenting the AR video call (e.g., presenting avatar 710 and digital representation of contact 712).

In some embodiments, HIPD 706 can operate as a focal or anchor point for causing the presentation of information. This allows user 708 to be generally aware of where information is presented. For example, as shown in first AR system 700, avatar 710 and the digital representation of contact 712 are presented above HIPD 706. In particular, HIPD 706 and AR glasses 704 operate in conjunction to determine a location for presenting avatar 710 and the digital representation of contact 712. In some embodiments, information can be presented a predetermined distance from HIPD 706 (e.g., within 5 meters). For example, as shown in first AR system 700, virtual object 714 is presented on the desk some distance from HIPD 706. Similar to the above example, HIPD 706 and AR glasses 704 can operate in conjunction to determine a location for presenting virtual object 714. Alternatively, in some embodiments, presentation of information is not bound by HIPD 706. More specifically, avatar 710, digital representation of contact 712, and virtual object 714 do not have to be presented within a predetermined distance of HIPD 706.

User inputs provided at wrist-wearable device 702, AR glasses 704, and/or HIPD 706 are coordinated such that the user can use any device to initiate, continue, and/or complete an operation. For example, user 708 can provide a user input to AR glasses 704 to cause AR glasses 704 to present virtual object 714 and, while virtual object 714 is presented by AR glasses 704, user 708 can provide one or more hand gestures via wrist-wearable device 702 to interact and/or manipulate virtual object 714.

FIG. 8 shows a user 808 wearing a wrist-wearable device 802 and AR glasses 804, and holding an HIPD 806. In second AR system 800, the wrist-wearable device 802, AR glasses 804, and/or HIPD 806 are used to receive and/or provide one or more messages to a contact of user 808. In particular, wrist-wearable device 802, AR glasses 804, and/or HIPD 806 detect and coordinate one or more user inputs to initiate a messaging application and prepare a response to a received message via the messaging application.

In some embodiments, user 808 initiates, via a user input, an application on wrist-wearable device 802, AR glasses 804, and/or HIPD 806 that causes the application to initiate on at least one device. For example, in second AR system 800, user 808 performs a hand gesture associated with a command for initiating a messaging application (represented by messaging user interface 816), wrist-wearable device 802 detects the hand gesture and, based on a determination that user 808 is wearing AR glasses 804, causes AR glasses 804 to present a messaging user interface 816 of the messaging application. AR glasses 804 can present messaging user interface 816 to user 808 via its display (e.g., as shown by a field of view 818 of user 808). In some embodiments, the application is initiated and executed on the device (e.g., wrist-wearable device 802, AR glasses 804, and/or HIPD 806) that detects the user input to initiate the application, and the device provides another device operational data to cause the presentation of the messaging application. For example, wrist-wearable device 802 can detect the user input to initiate a messaging application, initiate and run the messaging application, and provide operational data to AR glasses 804 and/or HIPD 806 to cause presentation of the messaging application. Alternatively, the application can be initiated and executed at a device other than the device that detected the user input. For example, wrist-wearable device 802 can detect the hand gesture associated with initiating the messaging application and cause HIPD 806 to run the messaging application and coordinate the presentation of the messaging application.

Further, user 808 can provide a user input provided at wrist-wearable device 802, AR glasses 804, and/or HIPD 806 to continue and/or complete an operation initiated at another device. For example, after initiating the messaging application via wrist-wearable device 802 and while AR glasses 804 present messaging user interface 816, user 808 can provide an input at HIPD 806 to prepare a response (e.g., shown by the swipe gesture performed on HIPD 806). Gestures performed by user 808 on HIPD 806 can be provided and/or displayed on another device. For example, a swipe gestured performed on HIPD 806 is displayed on a virtual keyboard of messaging user interface 816 displayed by AR glasses 804.

In some embodiments, wrist-wearable device 802, AR glasses 804, HIPD 806, and/or any other communicatively coupled device can present one or more notifications to user 808. The notification can be an indication of a new message, an incoming call, an application update, a status update, etc. User 808 can select the notification via wrist-wearable device 802, AR glasses 804, and/or HIPD 806 and can cause presentation of an application or operation associated with the notification on at least one device. For example, user 808 can receive a notification that a message was received at wrist-wearable device 802, AR glasses 804, HIPD 806, and/or any other communicatively coupled device and can then provide a user input at wrist-wearable device 802, AR glasses 804, and/or HIPD 806 to review the notification, and the device detecting the user input can cause an application associated with the notification to be initiated and/or presented at wrist-wearable device 802, AR glasses 804, and/or HIPD 806.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 804 can present to user 808 game application data, and HIPD 806 can be used as a controller to provide inputs to the game. Similarly, user 808 can use wrist-wearable device 802 to initiate a camera of AR glasses 804, and user 808 can use wrist-wearable device 802, AR glasses 804, and/or HIPD 806 to manipulate the image capture (e.g., zoom in or out, apply filters, etc.) and capture image data.

Users may interact with the devices disclosed herein in a variety of ways. For example, as shown in FIGS. 9A and 9B, a user 908 may interact with an AR system 900 by donning a VR headset 950 while holding HIPD 906 and wearing wrist-wearable device 902. In this example, AR system 900 may enable a user to interact with a game 910 by swiping their arm. One or more of VR headset 950, HIPD 906, and wrist-wearable device 902 may detect this gesture and, in response, may display a sword strike in game 910. Similarly, in FIGS. 10A and 10B, a user 1008 may interact with an AR system 1000 by donning a VR headset 1020 while wearing haptic device 1060 and wrist-wearable device 1030. In this example, AR system 1000 may enable a user to interact with a game 1010 by swiping their arm. One or more of VR headset 1020, haptic device 1060, and wrist-wearable device 1030 may detect this gesture and, in response, may display a spell being cast in game 910.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user’s heart rate, (v) SpO2 sensors for measuring blood oxygen saturation and/or other biometric data of a user, (vi) capacitive sensors for detecting changes in potential at a portion of a user’s body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 1302.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 11 and 12 illustrate an example wrist-wearable device 1100 and an example computer system 1200, in accordance with some embodiments. Wrist-wearable device 1100 is an instance of wearable device 702 described in FIG. 7 herein, such that the wearable device 702 should be understood to have the features of the wrist-wearable device 1100 and vice versa. FIG. 12 illustrates components of the wrist-wearable device 1100, which can be used individually or in combination, including combinations that include other electronic devices and/or electronic components.

FIG. 11 shows a wearable band 1110 and a watch body 1120 (or capsule) being coupled, as discussed below, to form wrist-wearable device 1100. Wrist-wearable device 1100 can perform various functions and/or operations associated with navigating through user interfaces and selectively opening applications as well as the functions and/or operations described above with reference to FIGS. 7-10B.

As will be described in more detail below, operations executed by wrist-wearable device 1100 can include (i) presenting content to a user (e.g., displaying visual content via a display 1105), (ii) detecting (e.g., sensing) user input (e.g., sensing a touch on peripheral button 1123 and/or at a touch screen of the display 1105, a hand gesture detected by sensors (e.g., biopotential sensors)), (iii) sensing biometric data (e.g., neuromuscular signals, heart rate, temperature, sleep, etc.) via one or more sensors 1113, messaging (e.g., text, speech, video, etc.); image capture via one or more imaging devices or cameras 1125, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 1120, independently in wearable band 1110, and/or via an electronic communication between watch body 1120 and wearable band 1110. In some embodiments, functions can be executed on wrist-wearable device 1100 while an AR environment is being presented (e.g., via one of AR systems 700 to 1000). The wearable devices described herein can also be used with other types of AR environments.

Wearable band 1110 can be configured to be worn by a user such that an inner surface of a wearable structure 1111 of wearable band 1110 is in contact with the user’s skin. In this example, when worn by a user, sensors 1113 may contact the user’s skin. In some examples, one or more of sensors 1113 can sense biometric data such as a user’s heart rate, a saturated oxygen level, temperature, sweat level, neuromuscular signals, or a combination thereof. One or more of sensors 1113 can also sense data about a user’s environment including a user’s motion, altitude, location, orientation, gait, acceleration, position, or a combination thereof. In some embodiment, one or more of sensors 1113 can be configured to track a position and/or motion of wearable band 1110. One or more of sensors 1113 can include any of the sensors defined above and/or discussed below with respect to FIG. 11.

One or more of sensors 1113 can be distributed on an inside and/or an outside surface of wearable band 1110. In some embodiments, one or more of sensors 1113 are uniformly spaced along wearable band 1110. Alternatively, in some embodiments, one or more of sensors 1113 are positioned at distinct points along wearable band 1110. As shown in FIG. 11, one or more of sensors 1113 can be the same or distinct. For example, in some embodiments, one or more of sensors 1113 can be shaped as a pill (e.g., sensor 1113a), an oval, a circle a square, an oblong (e.g., sensor 1113c) and/or any other shape that maintains contact with the user’s skin (e.g., such that neuromuscular signal and/or other biometric data can be accurately measured at the user’s skin). In some embodiments, one or more sensors of 1113 are aligned to form pairs of sensors (e.g., for sensing neuromuscular signals based on differential sensing within each respective sensor). For example, sensor 1113b may be aligned with an adjacent sensor to form sensor pair 1114a and sensor 1113d may be aligned with an adjacent sensor to form sensor pair 1114b. In some embodiments, wearable band 1110 does not have a sensor pair. Alternatively, in some embodiments, wearable band 1110 has a predetermined number of sensor pairs (one pair of sensors, three pairs of sensors, four pairs of sensors, six pairs of sensors, sixteen pairs of sensors, etc.).

Wearable band 1110 can include any suitable number of sensors 1113. In some embodiments, the number and arrangement of sensors 1113 depends on the particular application for which wearable band 1110 is used. For instance, wearable band 1110 can be configured as an armband, wristband, or chest-band that include a plurality of sensors 1113 with different number of sensors 1113, a variety of types of individual sensors with the plurality of sensors 1113, and different arrangements for each use case, such as medical use cases as compared to gaming or general day-to-day use cases.

In accordance with some embodiments, wearable band 1110 further includes an electrical ground electrode and a shielding electrode. The electrical ground and shielding electrodes, like the sensors 1113, can be distributed on the inside surface of the wearable band 1110 such that they contact a portion of the user’s skin. For example, the electrical ground and shielding electrodes can be at an inside surface of a coupling mechanism 1116 or an inside surface of a wearable structure 1111. The electrical ground and shielding electrodes can be formed and/or use the same components as sensors 1113. In some embodiments, wearable band 1110 includes more than one electrical ground electrode and more than one shielding electrode.

Sensors 1113 can be formed as part of wearable structure 1111 of wearable band 1110. In some embodiments, sensors 1113 are flush or substantially flush with wearable structure 1111 such that they do not extend beyond the surface of wearable structure 1111. While flush with wearable structure 1111, sensors 1113 are still configured to contact the user’s skin (e.g., via a skin-contacting surface). Alternatively, in some embodiments, sensors 1113 extend beyond wearable structure 1111 a predetermined distance (e.g., 0.1 – 2 mm) to make contact and depress into the user’s skin. In some embodiment, sensors 1113 are coupled to an actuator (not shown) configured to adjust an extension height (e.g., a distance from the surface of wearable structure 1111) of sensors 1113 such that sensors 1113 make contact and depress into the user’s skin. In some embodiments, the actuators adjust the extension height between 0.01 mm – 1.2 mm. This may allow a the user to customize the positioning of sensors 1113 to improve the overall comfort of the wearable band 1110 when worn while still allowing sensors 1113 to contact the user’s skin. In some embodiments, sensors 1113 are indistinguishable from wearable structure 1111 when worn by the user.

Wearable structure 1111 can be formed of an elastic material, elastomers, etc., configured to be stretched and fitted to be worn by the user. In some embodiments, wearable structure 1111 is a textile or woven fabric. As described above, sensors 1113 can be formed as part of a wearable structure 1111. For example, sensors 1113 can be molded into the wearable structure 1111, be integrated into a woven fabric (e.g., sensors 1113 can be sewn into the fabric and mimic the pliability of fabric and can and/or be constructed from a series woven strands of fabric).

Wearable structure 1111 can include flexible electronic connectors that interconnect sensors 1113, the electronic circuitry, and/or other electronic components (described below in reference to FIG. 12) that are enclosed in wearable band 1110. In some embodiments, the flexible electronic connectors are configured to interconnect sensors 1113, the electronic circuitry, and/or other electronic components of wearable band 1110 with respective sensors and/or other electronic components of another electronic device (e.g., watch body 1120). The flexible electronic connectors are configured to move with wearable structure 1111 such that the user adjustment to wearable structure 1111 (e.g., resizing, pulling, folding, etc.) does not stress or strain the electrical coupling of components of wearable band 1110.

As described above, wearable band 1110 is configured to be worn by a user. In particular, wearable band 1110 can be shaped or otherwise manipulated to be worn by a user. For example, wearable band 1110 can be shaped to have a substantially circular shape such that it can be configured to be worn on the user’s lower arm or wrist. Alternatively, wearable band 1110 can be shaped to be worn on another body part of the user, such as the user’s upper arm (e.g., around a bicep), forearm, chest, legs, etc. Wearable band 1110 can include a retaining mechanism 1112 (e.g., a buckle, a hook and loop fastener, etc.) for securing wearable band 1110 to the user’s wrist or other body part. While wearable band 1110 is worn by the user, sensors 1113 sense data (referred to as sensor data) from the user’s skin. In some examples, sensors 1113 of wearable band 1110 obtain (e.g., sense and record) neuromuscular signals.

The sensed data (e.g., sensed neuromuscular signals) can be used to detect and/or determine the user’s intention to perform certain motor actions. In some examples, sensors 1113 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 1105 of wrist-wearable device 1100 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user’s hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 1113 can be used to provide a user with an enhanced interaction with a physical object (e.g., devices communicatively coupled with wearable band 1110) and/or a virtual object in an artificial-reality application generated by an artificial-reality system (e.g., user interface objects presented on the display 1105, or another computing device (e.g., a smartphone)).

In some embodiments, wearable band 1110 includes one or more haptic devices 1246 (e.g., a vibratory haptic actuator) that are configured to provide haptic feedback (e.g., a cutaneous and/or kinesthetic sensation, etc.) to the user’s skin. Sensors 1113 and/or haptic devices 1246 (shown in FIG. 12) can be configured to operate in conjunction with multiple applications including, without limitation, health monitoring, social media, games, and artificial reality (e.g., the applications associated with artificial reality).

Wearable band 1110 can also include coupling mechanism 1116 for detachably coupling a capsule (e.g., a computing unit) or watch body 1120 (via a coupling surface of the watch body 1120) to wearable band 1110. For example, a cradle or a shape of coupling mechanism 1116 can correspond to shape of watch body 1120 of wrist-wearable device 1100. In particular, coupling mechanism 1116 can be configured to receive a coupling surface proximate to the bottom side of watch body 1120 (e.g., a side opposite to a front side of watch body 1120 where display 1105 is located), such that a user can push watch body 1120 downward into coupling mechanism 1116 to attach watch body 1120 to coupling mechanism 1116. In some embodiments, coupling mechanism 1116 can be configured to receive a top side of the watch body 1120 (e.g., a side proximate to the front side of watch body 1120 where display 1105 is located) that is pushed upward into the cradle, as opposed to being pushed downward into coupling mechanism 1116. In some embodiments, coupling mechanism 1116 is an integrated component of wearable band 1110 such that wearable band 1110 and coupling mechanism 1116 are a single unitary structure. In some embodiments, coupling mechanism 1116 is a type of frame or shell that allows watch body 1120 coupling surface to be retained within or on wearable band 1110 coupling mechanism 1116 (e.g., a cradle, a tracker band, a support base, a clasp, etc.).

Coupling mechanism 1116 can allow for watch body 1120 to be detachably coupled to the wearable band 1110 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1120 to wearable band 1110 and to decouple the watch body 1120 from the wearable band 1110. For example, a user can twist, slide, turn, push, pull, or rotate watch body 1120 relative to wearable band 1110, or a combination thereof, to attach watch body 1120 to wearable band 1110 and to detach watch body 1120 from wearable band 1110. Alternatively, as discussed below, in some embodiments, the watch body 1120 can be decoupled from the wearable band 1110 by actuation of a release mechanism 1129.

Wearable band 1110 can be coupled with watch body 1120 to increase the functionality of wearable band 1110 (e.g., converting wearable band 1110 into wrist-wearable device 1100, adding an additional computing unit and/or battery to increase computational resources and/or a battery life of wearable band 1110, adding additional sensors to improve sensed data, etc.). As described above, wearable band 1110 and coupling mechanism 1116 are configured to operate independently (e.g., execute functions independently) from watch body 1120. For example, coupling mechanism 1116 can include one or more sensors 1113 that contact a user’s skin when wearable band 1110 is worn by the user, with or without watch body 1120 and can provide sensor data for determining control commands.

A user can detach watch body 1120 from wearable band 1110 to reduce the encumbrance of wrist-wearable device 1100 to the user. For embodiments in which watch body 1120 is removable, watch body 1120 can be referred to as a removable structure, such that in these embodiments wrist-wearable device 1100 includes a wearable portion (e.g., wearable band 1110) and a removable structure (e.g., watch body 1120).

Turning to watch body 1120, in some examples watch body 1120 can have a substantially rectangular or circular shape. Watch body 1120 is configured to be worn by the user on their wrist or on another body part. More specifically, watch body 1120 is sized to be easily carried by the user, attached on a portion of the user’s clothing, and/or coupled to wearable band 1110 (forming the wrist-wearable device 1100). As described above, watch body 1120 can have a shape corresponding to coupling mechanism 1116 of wearable band 1110. In some embodiments, watch body 1120 includes a single release mechanism 1129 or multiple release mechanisms (e.g., two release mechanisms 1129 positioned on opposing sides of watch body 1120, such as spring-loaded buttons) for decoupling watch body 1120 from wearable band 1110. Release mechanism 1129 can include, without limitation, a button, a knob, a plunger, a handle, a lever, a fastener, a clasp, a dial, a latch, or a combination thereof.

A user can actuate release mechanism 1129 by pushing, turning, lifting, depressing, shifting, or performing other actions on release mechanism 1129. Actuation of release mechanism 1129 can release (e.g., decouple) watch body 1120 from coupling mechanism 1116 of wearable band 1110, allowing the user to use watch body 1120 independently from wearable band 1110 and vice versa. For example, decoupling watch body 1120 from wearable band 1110 can allow a user to capture images using rear-facing camera 1125b. Although release mechanism 1129 is shown positioned at a corner of watch body 1120, release mechanism 1129 can be positioned anywhere on watch body 1120 that is convenient for the user to actuate. In addition, in some embodiments, wearable band 1110 can also include a respective release mechanism for decoupling watch body 1120 from coupling mechanism 1116. In some embodiments, release mechanism 1129 is optional and watch body 1120 can be decoupled from coupling mechanism 1116 as described above (e.g., via twisting, rotating, etc.).

Watch body 1120 can include one or more peripheral buttons 1123 and 1127 for performing various operations at watch body 1120. For example, peripheral buttons 1123 and 1127 can be used to turn on or wake (e.g., transition from a sleep state to an active state) display 1105, unlock watch body 1120, increase or decrease a volume, increase or decrease a brightness, interact with one or more applications, interact with one or more user interfaces, etc. Additionally or alternatively, in some embodiments, display 1105 operates as a touch screen and allows the user to provide one or more inputs for interacting with watch body 1120.

In some embodiments, watch body 1120 includes one or more sensors 1121. Sensors 1121 of watch body 1120 can be the same or distinct from sensors 1113 of wearable band 1110. Sensors 1121 of watch body 1120 can be distributed on an inside and/or an outside surface of watch body 1120. In some embodiments, sensors 1121 are configured to contact a user’s skin when watch body 1120 is worn by the user. For example, sensors 1121 can be placed on the bottom side of watch body 1120 and coupling mechanism 1116 can be a cradle with an opening that allows the bottom side of watch body 1120 to directly contact the user’s skin. Alternatively, in some embodiments, watch body 1120 does not include sensors that are configured to contact the user’s skin (e.g., including sensors internal and/or external to the watch body 1120 that are configured to sense data of watch body 1120 and the surrounding environment). In some embodiments, sensors 1121 are configured to track a position and/or motion of watch body 1120.

Watch body 1120 and wearable band 1110 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 1120 and wearable band 1110 can share data sensed by sensors 1113 and 1121, as well as application and device specific information (e.g., active and/or available applications, output devices (e.g., displays, speakers, etc.), input devices (e.g., touch screens, microphones, imaging sensors, etc.).

In some embodiments, watch body 1120 can include, without limitation, a front-facing camera 1125a and/or a rear-facing camera 1125b, sensors 1121 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1263), a touch sensor, a sweat sensor, etc.). In some embodiments, watch body 1120 can include one or more haptic devices 1276 (e.g., a vibratory haptic actuator) that is configured to provide haptic feedback (e.g., a cutaneous and/or kinesthetic sensation, etc.) to the user. Sensors 1221 and/or haptic device 1276 can also be configured to operate in conjunction with multiple applications including, without limitation, health monitoring applications, social media applications, game applications, and artificial reality applications (e.g., the applications associated with artificial reality).

As described above, watch body 1120 and wearable band 1110, when coupled, can form wrist-wearable device 1100. When coupled, watch body 1120 and wearable band 1110 may operate as a single device to execute functions (operations, detections, communications, etc.) described herein. In some embodiments, each device may be provided with particular instructions for performing the one or more operations of wrist-wearable device 1100. For example, in accordance with a determination that watch body 1120 does not include neuromuscular signal sensors, wearable band 1110 can include alternative instructions for performing associated instructions (e.g., providing sensed neuromuscular signal data to watch body 1120 via a different electronic device). Operations of wrist-wearable device 1100 can be performed by watch body 1120 alone or in conjunction with wearable band 1110 (e.g., via respective processors and/or hardware components) and vice versa. In some embodiments, operations of wrist-wearable device 1100, watch body 1120, and/or wearable band 1110 can be performed in conjunction with one or more processors and/or hardware components.

As described below with reference to the block diagram of FIG. 12, wearable band 1110 and/or watch body 1120 can each include independent resources required to independently execute functions. For example, wearable band 1110 and/or watch body 1120 can each include a power source (e.g., a battery), a memory, data storage, a processor (e.g., a central processing unit (CPU)), communications, a light source, and/or input/output devices.

FIG. 12 shows block diagrams of a computing system 1230 corresponding to wearable band 1110 and a computing system 1260 corresponding to watch body 1120 according to some embodiments. Computing system 1200 of wrist-wearable device 1100 may include a combination of components of wearable band computing system 1230 and watch body computing system 1260, in accordance with some embodiments.

Watch body 1120 and/or wearable band 1110 can include one or more components shown in watch body computing system 1260. In some embodiments, a single integrated circuit may include all or a substantial portion of the components of watch body computing system 1260 included in a single integrated circuit. Alternatively, in some embodiments, components of the watch body computing system 1260 may be included in a plurality of integrated circuits that are communicatively coupled. In some embodiments, watch body computing system 1260 may be configured to couple (e.g., via a wired or wireless connection) with wearable band computing system 1230, which may allow the computing systems to share components, distribute tasks, and/or perform other operations described herein (individually or as a single device).

Watch body computing system 1260 can include one or more processors 1279, a controller 1277, a peripherals interface 1261, a power system 1295, and memory (e.g., a memory 1280).

Power system 1295 can include a charger input 1296, a power-management integrated circuit (PMIC) 1297, and a battery 1298. In some embodiments, a watch body 1120 and a wearable band 1110 can have respective batteries (e.g., battery 1298 and 1259) and can share power with each other. Watch body 1120 and wearable band 1110 can receive a charge using a variety of techniques. In some embodiments, watch body 1120 and wearable band 1110 can use a wired charging assembly (e.g., power cords) to receive the charge. Alternatively, or in addition, watch body 1120 and/or wearable band 1110 can be configured for wireless charging. For example, a portable charging device can be designed to mate with a portion of watch body 1120 and/or wearable band 1110 and wirelessly deliver usable power to battery 1298 of watch body 1120 and/or battery 1259 of wearable band 1110. Watch body 1120 and wearable band 1110 can have independent power systems (e.g., power system 1295 and 1256, respectively) to enable each to operate independently. Watch body 1120 and wearable band 1110 can also share power (e.g., one can charge the other) via respective PMICs (e.g., PMICs 1297 and 1258) and charger inputs (e.g., 1257 and 1296) that can share power over power and ground conductors and/or over wireless charging antennas.

In some embodiments, peripherals interface 1261 can include one or more sensors 1221. Sensors 1221 can include one or more coupling sensors 1262 for detecting when watch body 1120 is coupled with another electronic device (e.g., a wearable band 1110). Sensors 1221 can include one or more imaging sensors 1263 (e.g., one or more of cameras 1225, and/or separate imaging sensors 1263 (e.g., thermal-imaging sensors)). In some embodiments, sensors 1221 can include one or more SpO2 sensors 1264. In some embodiments, sensors 1221 can include one or more biopotential-signal sensors (e.g., EMG sensors 1265, which may be disposed on an interior, user-facing portion of watch body 1120 and/or wearable band 1110). In some embodiments, sensors 1221 may include one or more capacitive sensors 1266. In some embodiments, sensors 1221 may include one or more heart rate sensors 1267. In some embodiments, sensors 1221 may include one or more IMU sensors 1268. In some embodiments, one or more IMU sensors 1268 can be configured to detect movement of a user’s hand or other location where watch body 1120 is placed or held.

In some embodiments, one or more of sensors 1221 may provide an example human-machine interface. For example, a set of neuromuscular sensors, such as EMG sensors 1265, may be arranged circumferentially around wearable band 1110 with an interior surface of EMG sensors 1265 being configured to contact a user’s skin. Any suitable number of neuromuscular sensors may be used (e.g., between 2 and 20 sensors). The number and arrangement of neuromuscular sensors may depend on the particular application for which the wearable device is used. For example, wearable band 1110 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 1279. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 1265 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 1261 includes a near-field communication (NFC) component 1269, a global-position system (GPS) component 1270, a long-term evolution (LTE) component 1271, and/or a Wi-Fi and/or Bluetooth communication component 1272. In some embodiments, peripherals interface 1261 includes one or more buttons 1273 (e.g., peripheral buttons 1123 and 1127 in FIG. 11), which, when selected by a user, cause operation to be performed at watch body 1120. In some embodiments, the peripherals interface 1261 includes one or more indicators, such as a light emitting diode (LED), to provide a user with visual indicators (e.g., message received, low battery, active microphone and/or camera, etc.).

Watch body 1120 can include at least one display 1105 for displaying visual representations of information or data to a user, including user-interface elements and/or three-dimensional virtual objects. The display can also include a touch screen for inputting user inputs, such as touch gestures, swipe gestures, and the like. Watch body 1120 can include at least one speaker 1274 and at least one microphone 1275 for providing audio signals to the user and receiving audio input from the user. The user can provide user inputs through microphone 1275 and can also receive audio output from speaker 1274 as part of a haptic event provided by haptic controller 1278. Watch body 1120 can include at least one camera 1225, including a front camera 1225a and a rear camera 1225b. Cameras 1225 can include ultra-wide-angle cameras, wide angle cameras, fish-eye cameras, spherical cameras, telephoto cameras, depth-sensing cameras, or other types of cameras.

Watch body computing system 1260 can include one or more haptic controllers 1278 and associated componentry (e.g., haptic devices 1276) for providing haptic events at watch body 1120 (e.g., a vibrating sensation or audio output in response to an event at the watch body 1120). Haptic controllers 1278 can communicate with one or more haptic devices 1276, such as electroacoustic devices, including a speaker of the one or more speakers 1274 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 1278 can provide haptic events to that are capable of being sensed by a user of watch body 1120. In some embodiments, one or more haptic controllers 1278 can receive input signals from an application of applications 1282.

In some embodiments, wearable band computing system 1230 and/or watch body computing system 1260 can include memory 1280, which can be controlled by one or more memory controllers of controllers 1277. In some embodiments, software components stored in memory 1280 include one or more applications 1282 configured to perform operations at the watch body 1120. In some embodiments, one or more applications 1282 may include games, word processors, messaging applications, calling applications, web browsers, social media applications, media streaming applications, financial applications, calendars, clocks, etc. In some embodiments, software components stored in memory 1280 include one or more communication interface modules 1283 as defined above. In some embodiments, software components stored in memory 1280 include one or more graphics modules 1284 for rendering, encoding, and/or decoding audio and/or visual data and one or more data management modules 1285 for collecting, organizing, and/or providing access to data 1287 stored in memory 1280. In some embodiments, one or more of applications 1282 and/or one or more modules can work in conjunction with one another to perform various tasks at the watch body 1120.

In some embodiments, software components stored in memory 1280 can include one or more operating systems 1281 (e.g., a Linux-based operating system, an Android operating system, etc.). Memory 1280 can also include data 1287. Data 1287 can include profile data 1288A, sensor data 1289A, media content data 1290, and application data 1291.

It should be appreciated that watch body computing system 1260 is an example of a computing system within watch body 1120, and that watch body 1120 can have more or fewer components than shown in watch body computing system 1260, can combine two or more components, and/or can have a different configuration and/or arrangement of the components. The various components shown in watch body computing system 1260 are implemented in hardware, software, firmware, or a combination thereof, including one or more signal processing and/or application-specific integrated circuits.

Turning to the wearable band computing system 1230, one or more components that can be included in wearable band 1110 are shown. Wearable band computing system 1230 can include more or fewer components than shown in watch body computing system 1260, can combine two or more components, and/or can have a different configuration and/or arrangement of some or all of the components. In some embodiments, all, or a substantial portion of the components of wearable band computing system 1230 are included in a single integrated circuit. Alternatively, in some embodiments, components of wearable band computing system 1230 are included in a plurality of integrated circuits that are communicatively coupled. As described above, in some embodiments, wearable band computing system 1230 is configured to couple (e.g., via a wired or wireless connection) with watch body computing system 1260, which allows the computing systems to share components, distribute tasks, and/or perform other operations described herein (individually or as a single device).

Wearable band computing system 1230, similar to watch body computing system 1260, can include one or more processors 1249, one or more controllers 1247 (including one or more haptics controllers 1248), a peripherals interface 1231 that can includes one or more sensors 1213 and other peripheral devices, a power source (e.g., a power system 1256), and memory (e.g., a memory 1250) that includes an operating system (e.g., an operating system 1251), data (e.g., data 1254 including profile data 1288B, sensor data 1289B, etc.), and one or more modules (e.g., a communications interface module 1252, a data management module 1253, etc.).

One or more of sensors 1213 can be analogous to sensors 1221 of watch body computing system 1260. For example, sensors 1213 can include one or more coupling sensors 1232, one or more SpO2 sensors 1234, one or more EMG sensors 1235, one or more capacitive sensors 1236, one or more heart rate sensors 1237, and one or more IMU sensors 1238.

Peripherals interface 1231 can also include other components analogous to those included in peripherals interface 1261 of watch body computing system 1260, including an NFC component 1239, a GPS component 1240, an LTE component 1241, a Wi-Fi and/or Bluetooth communication component 1242, and/or one or more haptic devices 1246 as described above in reference to peripherals interface 1261. In some embodiments, peripherals interface 1231 includes one or more buttons 1243, a display 1233, a speaker 1244, a microphone 1245, and a camera 1255. In some embodiments, peripherals interface 1231 includes one or more indicators, such as an LED.

It should be appreciated that wearable band computing system 1230 is an example of a computing system within wearable band 1110, and that wearable band 1110 can have more or fewer components than shown in wearable band computing system 1230, combine two or more components, and/or have a different configuration and/or arrangement of the components. The various components shown in wearable band computing system 1230 can be implemented in one or more of a combination of hardware, software, or firmware, including one or more signal processing and/or application-specific integrated circuits.

Wrist-wearable device 1100 with respect to FIG. 11 is an example of wearable band 1110 and watch body 1120 coupled together, so wrist-wearable device 1100 will be understood to include the components shown and described for wearable band computing system 1230 and watch body computing system 1260. In some embodiments, wrist-wearable device 1100 has a split architecture (e.g., a split mechanical architecture, a split electrical architecture, etc.) between watch body 1120 and wearable band 1110. In other words, all of the components shown in wearable band computing system 1230 and watch body computing system 1260 can be housed or otherwise disposed in a combined wrist-wearable device 1100 or within individual components of watch body 1120, wearable band 1110, and/or portions thereof (e.g., a coupling mechanism 1116 of wearable band 1110).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 1100 can be used in conjunction with a head-wearable device (e.g., AR glasses 1300 and VR system 1400) and/or an HIPD 1600 described below, and wrist-wearable device 1100 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 1300 and VR headset 1400.

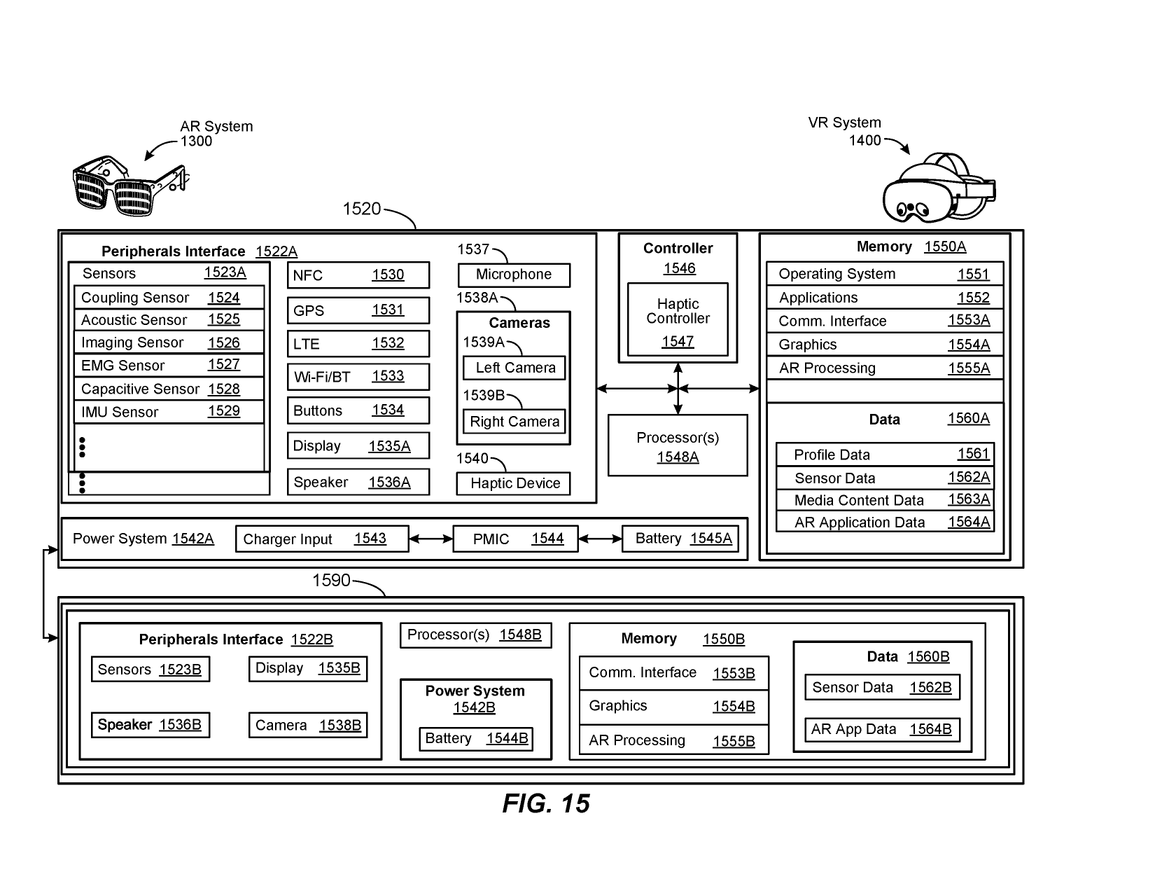

FIGS. 13 to 15 show example artificial-reality systems, which can be used as or in connection with wrist-wearable device 1100. In some embodiments, AR system 1300 includes an eyewear device 1302, as shown in FIG. 13. In some embodiments, VR system 1400 includes a head-mounted display (HMD) 1412, as shown in FIGS. 14A and 14B. In some embodiments, AR system 1300 and VR system 1400 can include one or more analogous components (e.g., components for presenting interactive artificial-reality environments, such as processors, memory, and/or presentation devices, including one or more displays and/or one or more waveguides), some of which are described in more detail with respect to FIG. 15. As described herein, a head-wearable device can include components of eyewear device 1302 and/or head-mounted display 1412. Some embodiments of head-wearable devices do not include any displays, including any of the displays described with respect to AR system 1300 and/or VR system 1400. While the example artificial-reality systems are respectively described herein as AR system 1300 and VR system 1400, either or both of the example AR systems described herein can be configured to present fully-immersive virtual-reality scenes presented in substantially all of a user’s field of view or subtler augmented-reality scenes that are presented within a portion, less than all, of the user’s field of view.

FIG. 13 show an example visual depiction of AR system 1300, including an eyewear device 1302 (which may also be described herein as augmented-reality glasses, and/or smart glasses). AR system 1300 can include additional electronic components that are not shown in FIG. 13, such as a wearable accessory device and/or an intermediary processing device, in electronic communication or otherwise configured to be used in conjunction with the eyewear device 1302. In some embodiments, the wearable accessory device and/or the intermediary processing device may be configured to couple with eyewear device 1302 via a coupling mechanism in electronic communication with a coupling sensor 1524 (FIG. 15), where coupling sensor 1524 can detect when an electronic device becomes physically or electronically coupled with eyewear device 1302. In some embodiments, eyewear device 1302 can be configured to couple to a housing 1590 (FIG. 15), which may include one or more additional coupling mechanisms configured to couple with additional accessory devices. The components shown in FIG. 13 can be implemented in hardware, software, firmware, or a combination thereof, including one or more signal-processing components and/or application-specific integrated circuits (ASICs).

Eyewear device 1302 includes mechanical glasses components, including a frame 1304 configured to hold one or more lenses (e.g., one or both lenses 1306-1 and 1306-2). One of ordinary skill in the art will appreciate that eyewear device 1302 can include additional mechanical components, such as hinges configured to allow portions of frame 1304 of eyewear device 1302 to be folded and unfolded, a bridge configured to span the gap between lenses 1306-1 and 1306-2 and rest on the user’s nose, nose pads configured to rest on the bridge of the nose and provide support for eyewear device 1302, earpieces configured to rest on the user’s ears and provide additional support for eyewear device 1302, temple arms configured to extend from the hinges to the earpieces of eyewear device 1302, and the like. One of ordinary skill in the art will further appreciate that some examples of AR system 1300 can include none of the mechanical components described herein. For example, smart contact lenses configured to present artificial reality to users may not include any components of eyewear device 1302.

Eyewear device 1302 includes electronic components, many of which will be described in more detail below with respect to FIG. 15. Some example electronic components are illustrated in FIG. 13, including acoustic sensors 1325-1, 1325-2, 1325-3, 1325-4, 1325-5, and 1325-6, which can be distributed along a substantial portion of the frame 1304 of eyewear device 1302. Eyewear device 1302 also includes a left camera 1339A and a right camera 1339B, which are located on different sides of the frame 1304. Eyewear device 1302 also includes a processor 1348 (or any other suitable type or form of integrated circuit) that is embedded into a portion of the frame 1304.

FIGS. 14A and 14B show a VR system 1400 that includes a head-mounted display (HMD) 1412 (e.g., also referred to herein as an artificial-reality headset, a head-wearable device, a VR headset, etc.), in accordance with some embodiments. As noted, some artificial-reality systems (e.g., AR system 1300) may, instead of blending an artificial reality with actual reality, substantially replace one or more of a user’s visual and/or other sensory perceptions of the real world with a virtual experience (e.g., AR systems 900 and 1000).

HMD 1412 includes a front body 1414 and a frame 1416 (e.g., a strap or band) shaped to fit around a user’s head. In some embodiments, front body 1414 and/or frame 1416 include one or more electronic elements for facilitating presentation of and/or interactions with an AR and/or VR system (e.g., displays, IMUs, tracking emitter or detectors). In some embodiments, HMD 1412 includes output audio transducers (e.g., an audio transducer 1418), as shown in FIG. 14B. In some embodiments, one or more components, such as the output audio transducer(s) 1418 and frame 1416, can be configured to attach and detach (e.g., are detachably attachable) to HMD 1412 (e.g., a portion or all of frame 1416, and/or audio transducer 1418), as shown in FIG. 14B. In some embodiments, coupling a detachable component to HMD 1412 causes the detachable component to come into electronic communication with HMD 1412.

FIGS. 14A and 14B also show that VR system 1400 includes one or more cameras, such as left camera 1439A and right camera 1439B, which can be analogous to left and right cameras 1339A and 1339B on frame 1304 of eyewear device 1302. In some embodiments, VR system 1400 includes one or more additional cameras (e.g., cameras 1439C and 1439D), which can be configured to augment image data obtained by left and right cameras 1439A and 1439B by providing more information. For example, camera 1439C can be used to supply color information that is not discerned by cameras 1439A and 1439B. In some embodiments, one or more of cameras 1439A to 1439D can include an optional IR cut filter configured to remove IR light from being received at the respective camera sensors.

FIG. 15 illustrates a computing system 1520 and an optional housing 1590, each of which show components that can be included in AR system 1300 and/or VR system 1400. In some embodiments, more or fewer components can be included in optional housing 1590 depending on practical restraints of the respective AR system being described.

In some embodiments, computing system 1520 can include one or more peripherals interfaces 1522A and/or optional housing 1590 can include one or more peripherals interfaces 1522B. Each of computing system 1520 and optional housing 1590 can also include one or more power systems 1542A and 1542B, one or more controllers 1546 (including one or more haptic controllers 1547), one or more processors 1548A and 1548B (as defined above, including any of the examples provided), and memory 1550A and 1550B, which can all be in electronic communication with each other. For example, the one or more processors 1548A and 1548B can be configured to execute instructions stored in memory 1550A and 1550B, which can cause a controller of one or more of controllers 1546 to cause operations to be performed at one or more peripheral devices connected to peripherals interface 1522A and/or 1522B. In some embodiments, each operation described can be powered by electrical power provided by power system 1542A and/or 1542B.

In some embodiments, peripherals interface 1522A can include one or more devices configured to be part of computing system 1520, some of which have been defined above and/or described with respect to the wrist-wearable devices shown in FIGS. 11 and 12. For example, peripherals interface 1522A can include one or more sensors 1523A. Some example sensors 1523A include one or more coupling sensors 1524, one or more acoustic sensors 1525, one or more imaging sensors 1526, one or more EMG sensors 1527, one or more capacitive sensors 1528, one or more IMU sensors 1529, and/or any other types of sensors explained above or described with respect to any other embodiments discussed herein.

In some embodiments, peripherals interfaces 1522A and 1522B can include one or more additional peripheral devices, including one or more NFC devices 1530, one or more GPS devices 1531, one or more LTE devices 1532, one or more Wi-Fi and/or Bluetooth devices 1533, one or more buttons 1534 (e.g., including buttons that are slidable or otherwise adjustable), one or more displays 1535A and 1535B, one or more speakers 1536A and 1536B, one or more microphones 1537, one or more cameras 1538A and 1538B (e.g., including the left camera 1539A and/or a right camera 1539B), one or more haptic devices 1540, and/or any other types of peripheral devices defined above or described with respect to any other embodiments discussed herein.

AR systems can include a variety of types of visual feedback mechanisms (e.g., presentation devices). For example, display devices in AR system 1300 and/or VR system 1400 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user’s vision. Some embodiments of AR systems also include optical subsystems having one or more lenses (e.g., conventional concave or convex lenses, Fresnel lenses, or adjustable liquid lenses) through which a user can view a display screen.

For example, respective displays 1535A and 1535B can be coupled to each of the lenses 1306-1 and 1306-2 of AR system 1300. Displays 1535A and 1535B may be coupled to each of lenses 1306-1 and 1306-2, which can act together or independently to present an image or series of images to a user. In some embodiments, AR system 1300 includes a single display 1535A or 1535B (e.g., a near-eye display) or more than two displays 1535A and 1535B. In some embodiments, a first set of one or more displays 1535A and 1535B can be used to present an augmented-reality environment, and a second set of one or more display devices 1535A and 1535B can be used to present a virtual-reality environment. In some embodiments, one or more waveguides are used in conjunction with presenting artificial-reality content to the user of AR system 1300 (e.g., as a means of delivering light from one or more displays 1535A and 1535B to the user’s eyes). In some embodiments, one or more waveguides are fully or partially integrated into the eyewear device 1302. Additionally, or alternatively to display screens, some artificial-reality systems include one or more projection systems. For example, display devices in AR system 1300 and/or VR system 1400 can include micro-LED projectors that project light (e.g., using a waveguide) into display devices, such as clear combiner lenses that allow ambient light to pass through. The display devices can refract the projected light toward a user’s pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 1535A and 1535B.

Computing system 1520 and/or optional housing 1590 of AR system 1300 or VR system 1400 can include some or all of the components of a power system 1542A and 1542B. Power systems 1542A and 1542B can include one or more charger inputs 1543, one or more PMICs 1544, and/or one or more batteries 1545A and 1544B.

Memory 1550A and 1550B may include instructions and data, some or all of which may be stored as non-transitory computer-readable storage media within the memories 1550A and 1550B. For example, memory 1550A and 1550B can include one or more operating systems 1551, one or more applications 1552, one or more communication interface applications 1553A and 1553B, one or more graphics applications 1554A and 1554B, one or more AR processing applications 1555A and 1555B, and/or any other types of data defined above or described with respect to any other embodiments discussed herein.

Memory 1550A and 1550B also include data 1560A and 1560B, which can be used in conjunction with one or more of the applications discussed above. Data 1560A and 1560B can include profile data 1561, sensor data 1562A and 1562B, media content data 1563A, AR application data 1564A and 1564B, and/or any other types of data defined above or described with respect to any other embodiments discussed herein.

In some embodiments, controller 1546 of eyewear device 1302 may process information generated by sensors 1523A and/or 1523B on eyewear device 1302 and/or another electronic device within AR system 1300. For example, controller 1546 can process information from acoustic sensors 1325-1 and 1325-2. For each detected sound, controller 1546 can perform a direction of arrival (DOA) estimation to estimate a direction from which the detected sound arrived at eyewear device 1302 of AR system 1300. As one or more of acoustic sensors 1525 (e.g., the acoustic sensors 1325-1, 1325-2) detects sounds, controller 1546 can populate an audio data set with the information (e.g., represented in FIG. 15 as sensor data 1562A and 1562B).

In some embodiments, a physical electronic connector can convey information between eyewear device 1302 and another electronic device and/or between one or more processors 1348, 1548A, 1548B of AR system 1300 or VR system 1400 and controller 1546. The information can be in the form of optical data, electrical data, wireless data, or any other transmittable data form. Moving the processing of information generated by eyewear device 1302 to an intermediary processing device can reduce weight and heat in the eyewear device, making it more comfortable and safer for a user. In some embodiments, an optional wearable accessory device (e.g., an electronic neckband) is coupled to eyewear device 1302 via one or more connectors. The connectors can be wired or wireless connectors and can include electrical and/or non-electrical (e.g., structural) components. In some embodiments, eyewear device 1302 and the wearable accessory device can operate independently without any wired or wireless connection between them.

In some situations, pairing external devices, such as an intermediary processing device (e.g., HIPD 706, 806, 906) with eyewear device 1302 (e.g., as part of AR system 1300) enables eyewear device 1302 to achieve a similar form factor of a pair of glasses while still providing sufficient battery and computation power for expanded capabilities. Some, or all, of the battery power, computational resources, and/or additional features of AR system 1300 can be provided by a paired device or shared between a paired device and eyewear device 1302, thus reducing the weight, heat profile, and form factor of eyewear device 1302 overall while allowing eyewear device 1302 to retain its desired functionality. For example, the wearable accessory device can allow components that would otherwise be included on eyewear device 1302 to be included in the wearable accessory device and/or intermediary processing device, thereby shifting a weight load from the user’s head and neck to one or more other portions of the user’s body. In some embodiments, the intermediary processing device has a larger surface area over which to diffuse and disperse heat to the ambient environment. Thus, the intermediary processing device can allow for greater battery and computation capacity than might otherwise have been possible on eyewear device 1302 standing alone. Because weight carried in the wearable accessory device can be less invasive to a user than weight carried in the eyewear device 1302, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user’s day-to-day activities.

AR systems can include various types of computer vision components and subsystems. For example, AR system 1300 and/or VR system 1400 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use’s real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 14A and 14B show VR system 1400 having cameras 1439A to 1439D, which can be used to provide depth information for creating a voxel field and a two-dimensional mesh to provide object information to the user to avoid collisions.

In some embodiments, AR system 1300 and/or VR system 1400 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1300 and/or VR system 1400, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented 1400 within a user’s field of view (e.g., a portion of the AR environment co-located with a physical object in the user’s real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

FIGS. 16A and 16B illustrate an example handheld intermediary processing device (HIPD) 1600 in accordance with some embodiments. HIPD 1600 is an instance of the intermediary device described herein, such that HIPD 1600 should be understood to have the features described with respect to any intermediary device defined above or otherwise described herein and vice versa. FIG. 16A shows a top view and FIG. 16B shows a side view of the HIPD 1600. HIPD 1600 is configured to communicatively couple with one or more wearable devices (or other electronic devices) associated with a user. For example, HIPD 1600 is configured to communicatively couple with a user’s wrist-wearable device 702, 802 (or components thereof, such as watch body 1120 and wearable band 1110), AR glasses 1300, and/or VR headset 950 and 1400. HIPD 1600 can be configured to be held by a user (e.g., as a handheld controller), carried on the user’s person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which HIPD 1600 can successfully be communicatively coupled with an electronic device, such as a wearable device).

HIPD 1600 can perform various functions independently and/or in conjunction with one or more wearable devices (e.g., wrist-wearable device 702, AR glasses 1300, VR system 1400, etc.). HIPD 1600 can be configured to increase and/or improve the functionality of communicatively coupled devices, such as the wearable devices. HIPD 1600 can be configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 7-9B. Additionally, as will be described in more detail below, functionality and/or operations of HIPD 1600 can include, without limitation, task offloading and/or handoffs; thermals offloading and/or handoffs; six degrees of freedom (6DoF) raycasting and/or gaming (e.g., using imaging devices or cameras 1614A, 1614B, which can be used for simultaneous localization and mapping (SLAM) and/or with other image processing techniques), portable charging, messaging, image capturing via one or more imaging devices or cameras 1622A and 1622B, sensing user input (e.g., sensing a touch on a touch input surface 1602), wireless communications and/or interlining (e.g., cellular, near field, Wi-Fi, personal area network, etc.), location determination, financial transactions, providing haptic feedback, alarms, notifications, biometric authentication, health monitoring, sleep monitoring, etc. The above-described example functions can be executed independently in HIPD 1600 and/or in communication between HIPD 1600 and another wearable device described herein. In some embodiments, functions can be executed on HIPD 1600 in conjunction with an AR environment. As the skilled artisan will appreciate upon reading the descriptions provided herein that HIPD 1600 can be used with any type of suitable AR environment.

While HIPD 1600 is communicatively coupled with a wearable device and/or other electronic device, HIPD 1600 is configured to perform one or more operations initiated at the wearable device and/or the other electronic device. In particular, one or more operations of the wearable device and/or the other electronic device can be offloaded to HIPD 1600 to be performed. HIPD 1600 performs the one or more operations of the wearable device and/or the other electronic device and provides to data corresponded to the completed operations to the wearable device and/or the other electronic device. For example, a user can initiate a video stream using AR glasses 1300 and back-end tasks associated with performing the video stream (e.g., video rendering) can be offloaded to HIPD 1600, which HIPD 1600 performs and provides corresponding data to AR glasses 1300 to perform remaining front-end tasks associated with the video stream (e.g., presenting the rendered video data via a display of AR glasses 1300). In this way, HIPD 1600, which has more computational resources and greater thermal headroom than a wearable device, can perform computationally intensive tasks for the wearable device, thereby improving performance of an operation performed by the wearable device.

HIPD 1600 includes a multi-touch input surface 1602 on a first side (e.g., a front surface) that is configured to detect one or more user inputs. In particular, multi-touch input surface 1602 can detect single tap inputs, multi-tap inputs, swipe gestures and/or inputs, force-based and/or pressure-based touch inputs, held taps, and the like. Multi-touch input surface 1602 is configured to detect capacitive touch inputs and/or force (and/or pressure) touch inputs. Multi-touch input surface 1602 includes a first touch-input surface 1604 defined by a surface depression and a second touch-input surface 1606 defined by a substantially planar portion. First touch-input surface 1604 can be disposed adjacent to second touch-input surface 1606. In some embodiments, first touch-input surface 1604 and second touch-input surface 1606 can be different dimensions and/or shapes. For example, first touch-input surface 1604 can be substantially circular and second touch-input surface 1606 can be substantially rectangular. In some embodiments, the surface depression of multi-touch input surface 1602 is configured to guide user handling of HIPD 1600. In particular, the surface depression can be configured such that the user holds HIPD 1600 upright when held in a single hand (e.g., such that the using imaging devices or cameras 1614A and 1614B are pointed toward a ceiling or the sky). Additionally, the surface depression is configured such that the user’s thumb rests within first touch-input surface 1604.

In some embodiments, the different touch-input surfaces include a plurality of touch-input zones. For example, second touch-input surface 1606 includes at least a second touch-input zone 1608 within a first touch-input zone 1607 and a third touch-input zone 1610 within second touch-input zone 1608. In some embodiments, one or more of touch-input zones 1608 and 1610 are optional and/or user defined (e.g., a user can specific a touch-input zone based on their preferences). In some embodiments, each touch-input surface 1604 and 1606 and/or touch-input zone 1608 and 1610 are associated with a predetermined set of commands. For example, a user input detected within first touch-input zone 1608 may cause HIPD 1600 to perform a first command and a user input detected within second touch-input surface 1606 may cause HIPD 1600 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, first touch-input zone 1608 can be configured to detect force touch inputs (e.g., a magnitude at which the user presses down) and capacitive touch inputs, and second touch-input zone 1610 can be configured to detect capacitive touch inputs.

As shown in FIG. 17, HIPD 1600 includes one or more sensors 1751 for sensing data used in the performance of one or more operations and/or functions. For example, HIPD 1600 can include an IMU sensor that is used in conjunction with cameras 1614A, 1614B (FIGS. 16A-16B) for 3-dimensional object manipulation (e.g., enlarging, moving, destroying, etc., an object) in an AR or VR environment. Non-limiting examples of sensors 1751 included in HIPD 1600 include a light sensor, a magnetometer, a depth sensor, a pressure sensor, and a force sensor.

HIPD 1600 can include one or more light indicators 1612 to provide one or more notifications to the user. In some embodiments, light indicators 1612 are LEDs or other types of illumination devices. Light indicators 1612 can operate as a privacy light to notify the user and/or others near the user that an imaging device and/or microphone are active. In some embodiments, a light indicator is positioned adjacent to one or more touch-input surfaces. For example, a light indicator can be positioned around first touch-input surface 1604. Light indicators 1612 can be illuminated in different colors and/or patterns to provide the user with one or more notifications and/or information about the device. For example, a light indicator positioned around first touch-input surface 1604 may flash when the user receives a notification (e.g., a message), change red when HIPD 1600 is out of power, operate as a progress bar (e.g., a light ring that is closed when a task is completed (e.g., 0% to 100%)), operate as a volume indicator, etc.

In some embodiments, HIPD 1600 includes one or more additional sensors on another surface. For example, as shown FIG. 16A, HIPD 1600 includes a set of one or more sensors (e.g., sensor set 1620) on an edge of HIPD 1600. Sensor set 1620, when positioned on an edge of the of HIPD 1600, can be pe positioned at a predetermined tilt angle (e.g., 26 degrees), which allows sensor set 1620 to be angled toward the user when placed on a desk or other flat surface. Alternatively, in some embodiments, sensor set 1620 is positioned on a surface opposite the multi-touch input surface 1602 (e.g., a back surface). The one or more sensors of sensor set 1620 are discussed in further detail below.

The side view of the of HIPD 1600 in FIG. 16B shows sensor set 1620 and camera 1614B. Sensor set 1620 can include one or more cameras 1622A and 1622B, a depth projector 1624, an ambient light sensor 1628, and a depth receiver 1630. In some embodiments, sensor set 1620 includes a light indicator 1626. Light indicator 1626 can operate as a privacy indicator to let the user and/or those around them know that a camera and/or microphone is active. Sensor set 1620 is configured to capture a user’s facial expression such that the user can puppet a custom avatar (e.g., showing emotions, such as smiles, laughter, etc., on the avatar or a digital representation of the user). Sensor set 1620 can be configured as a side stereo RGB system, a rear indirect Time-of-Flight (iToF) system, or a rear stereo RGB system. As the skilled artisan will appreciate upon reading the descriptions provided herein, HIPD 1600 described herein can use different sensor set 1620 configurations and/or sensor set 1620 placement.

Turning to FIG. 17, in some embodiments, a computing system 1740 of HIPD 1600 can include one or more haptic devices 1771 (e.g., a vibratory haptic actuator) that are configured to provide haptic feedback (e.g., kinesthetic sensation). Sensors 1751 and/or the haptic devices 1771 can be configured to operate in conjunction with multiple applications and/or communicatively coupled devices including, without limitation, a wearable devices, health monitoring applications, social media applications, game applications, and artificial reality applications (e.g., the applications associated with artificial reality).

In some embodiments, HIPD 1600 is configured to operate without a display. However, optionally, computing system 1740 of the HIPD 1600 can include a display 1768. HIPD 1600 can also include one or more optional peripheral buttons 1767. For example, peripheral buttons 1767 can be used to turn on or turn off HIPD 1600. Further, HIPD 1600 housing can be formed of polymers and/or elastomers. In other words, HIPD 1600 may be designed such that it would not easily slide off a surface. In some embodiments, HIPD 1600 includes one or magnets to couple HIPD 1600 to another surface. This allows the user to mount HIPD 1600 to different surfaces and provide the user with greater flexibility in use of HIPD 1600.

As described above, HIPD 1600 can distribute and/or provide instructions for performing the one or more tasks at HIPD 1600 and/or a communicatively coupled device. For example, HIPD 1600 can identify one or more back-end tasks to be performed by HIPD 1600 and one or more front-end tasks to be performed by a communicatively coupled device. While HIPD 1600 is configured to offload and/or handoff tasks of a communicatively coupled device, HIPD 1600 can perform both back-end and front-end tasks (e.g., via one or more processors, such as CPU 1777). HIPD 1600 can, without limitation, can be used to perform augmented calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. HIPD 1600 can perform the above operations alone or in conjunction with a wearable device (or other communicatively coupled electronic device).

FIG. 17 shows a block diagram of a computing system 1740 of HIPD 1600 in accordance with some embodiments. HIPD 1600, described in detail above, can include one or more components shown in HIPD computing system 1740. HIPD 1600 will be understood to include the components shown and described below for HIPD computing system 1740. In some embodiments, all, or a substantial portion of the components of HIPD computing system 1740 are included in a single integrated circuit. Alternatively, in some embodiments, components of HIPD computing system 1740 are included in a plurality of integrated circuits that are communicatively coupled.

HIPD computing system 1740 can include a processor (e.g., a CPU 1777, a GPU, and/or a CPU with integrated graphics), a controller 1775, a peripherals interface 1750 that includes one or more sensors 1751 and other peripheral devices, a power source (e.g., a power system 1795), and memory (e.g., a memory 1778) that includes an operating system (e.g., an operating system 1779), data (e.g., data 1788), one or more applications (e.g., applications 1780), and one or more modules (e.g., a communications interface module 1781, a graphics module 1782, a task and processing management module 1783, an interoperability module 1784, an AR processing module 1785, a data management module 1786, etc.). HIPD computing system 1740 further includes a power system 1795 that includes a charger input and output 1796, a PMIC 1797, and a battery 1798, all of which are defined above.

In some embodiments, peripherals interface 1750 can include one or more sensors 1751. Sensors 1751 can include analogous sensors to those described above in reference to FIG. 11. For example, sensors 1751 can include imaging sensors 1754, (optional) EMG sensors 1756, IMU sensors 1758, and capacitive sensors 1760. In some embodiments, sensors 1751 can include one or more pressure sensors 1752 for sensing pressure data, an altimeter 1753 for sensing an altitude of the HIPD 1600, a magnetometer 1755 for sensing a magnetic field, a depth sensor 1757 (or a time-of flight sensor) for determining a difference between the camera and the subject of an image, a position sensor 1759 (e.g., a flexible position sensor) for sensing a relative displacement or position change of a portion of the HIPD 1600, a force sensor 1761 for sensing a force applied to a portion of the HIPD 1600, and a light sensor 1762 (e.g., an ambient light sensor) for detecting an amount of lighting. Sensors 1751 can include one or more sensors not shown in FIG. 17.

Analogous to the peripherals described above in reference to FIG. 11, peripherals interface 1750 can also include an NFC component 1763, a GPS component 1764, an LTE component 1765, a Wi-Fi and/or Bluetooth communication component 1766, a speaker 1769, a haptic device 1771, and a microphone 1773. As noted above, HIPD 1600 can optionally include a display 1768 and/or one or more peripheral buttons 1767. Peripherals interface 1750 can further include one or more cameras 1770, touch surfaces 1772, and/or one or more light emitters 1774. Multi-touch input surface 1602 described above in reference to FIGS. 16A and 16B is an example of touch surface 1772. Light emitters 1774 can be one or more LEDs, lasers, etc. and can be used to project or present information to a user. For example, light emitters 1774 can include light indicators 1612 and 1626 described above in reference to FIGS. 16A and 16B. Cameras 1770 (e.g., cameras 1614A, 1614B, 1622A, and 1622B described above in reference to FIGS. 16A and 16B) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other suitable cameras. Cameras 1770 can be used for SLAM, 6DoF ray casting, gaming, object manipulation and/or other rendering, facial recognition and facial expression recognition, etc.

Similar to watch body computing system 1260 and watch band computing system 1230 described above in reference to FIG. 12, HIPD computing system 1740 can include one or more haptic controllers 1776 and associated componentry (e.g., haptic devices 1771) for providing haptic events at HIPD 1600.

Memory 1778 can include high-speed random-access memory and/or non-volatile memory, such as one or more magnetic disk storage devices, flash memory devices, or other non-volatile solid-state memory devices. Access to memory 1778 by other components of HIPD 1600, such as the one or more processors and peripherals interface 1750, can be controlled by a memory controller of controllers 1775.

In some embodiments, software components stored in memory 1778 include one or more operating systems 1779, one or more applications 1780, one or more communication interface modules 1781, one or more graphics modules 1782, and/or one or more data management modules 1786, which are analogous to the software components described above in reference to FIG. 11.

In some embodiments, software components stored in memory 1778 include a task and processing management module 1783 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, task and processing management module 1783 uses data 1788 (e.g., device data 1790) to distribute the one or more front-end and/or back-end tasks based on communicatively coupled devices’ computing resources, available power, thermal headroom, ongoing operations, and/or other factors. For example, task and processing management module 1783 can cause the performance of one or more back-end tasks (of an operation performed at communicatively coupled AR system 1300 ) at HIPD 1600 in accordance with a determination that the operation is utilizing a predetermined amount (e.g., at least 70%) of computing resources available at AR system 1300 .

In some embodiments, software components stored in memory 1778 include an interoperability module 1784 for exchanging and utilizing information received and/or provided to distinct communicatively coupled devices. Interoperability module 1784 allows for different systems, devices, and/or applications to connect and communicate in a coordinated way without user input. In some embodiments, software components stored in memory 1778 include an AR processing module 1785 that is configured to process signals based at least on sensor data for use in an AR and/or VR environment. For example, AR processing module 1785 can be used for 3D object manipulation, gesture recognition, facial and facial expression recognition, etc.

Memory 1778 can also include data 1788. In some embodiments, data 1788 can include profile data 1789, device data 1790 (including device data of one or more devices communicatively coupled with HIPD 1600, such as device type, hardware, software, configurations, etc.), sensor data 1791, media content data 1792, and application data 1793.

It should be appreciated that HIPD computing system 1740 is an example of a computing system within HIPD 1600, and that HIPD 1600 can have more or fewer components than shown in HIPD computing system 1740, combine two or more components, and/or have a different configuration and/or arrangement of the components. The various components shown HIPD computing system 1740 are implemented in hardware, software, firmware, or a combination thereof, including one or more signal processing and/or application-specific integrated circuits.

The techniques described above in FIGS. 16A, 16B, and 17 can be used with any device used as a human-machine interface controller. In some embodiments, an HIPD 1600 can be used in conjunction with one or more wearable device such as a head-wearable device (e.g., AR system 1300 and VR system 1400) and/or a wrist-wearable device 1100 (or components thereof).

In some embodiments, the artificial reality devices and/or accessory devices disclosed herein may include haptic interfaces with transducers that provide haptic feedback and/or that collect haptic information about a user’s interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons). In some examples, cutaneous feedback may include vibration, force, traction, texture, and/or temperature. Similarly, kinesthetic feedback, may include motion and compliance. Cutaneous and/or kinesthetic feedback may be provided using motors, piezoelectric actuators, fluidic systems, and/or a variety of other types of feedback mechanisms. Furthermore, haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user’s real-world experience in a variety of contexts and environments. For instance, artificial-reality systems may assist or extend a user’s perception, memory, or cognition within a particular environment. Some systems may enhance a user’s interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The haptics assemblies disclosed herein may enable or enhance a user’s artificial-reality experience in one or more of these contexts and environments and/or in other contexts and environments.

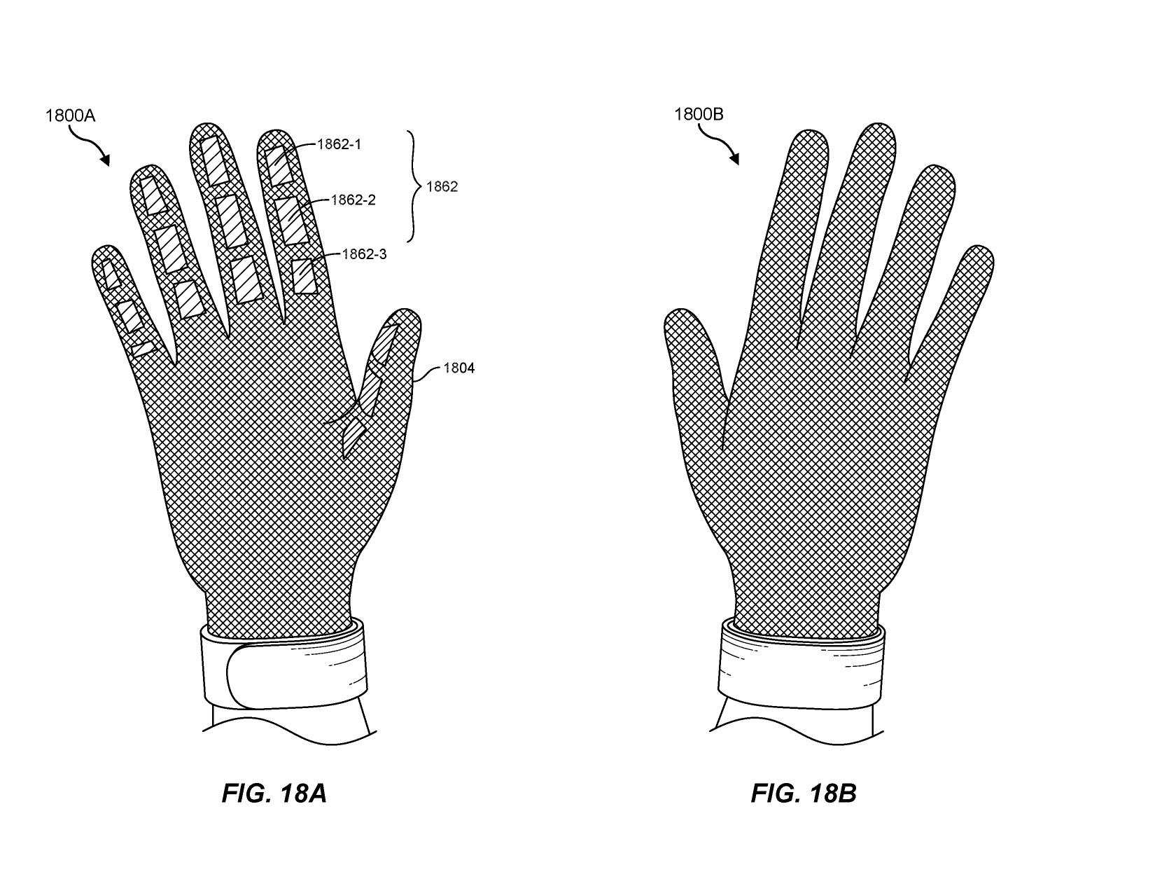

FIGS. 18A and 18B show example haptic feedback systems (e.g., hand-wearable devices) for providing feedback to a user regarding the user’s interactions with a computing system (e.g., an artificial-reality environment presented by the AR system 1300 or the VR system 1400). In some embodiments, a computing system (e.g., the AR systems 900 and/or 1000) may also provide feedback to one or more users based on an action that was performed within the computing system and/or an interaction provided by the AR system (e.g., which may be based on instructions that are executed in conjunction with performing operations of an application of the computing system). Such feedback may include visual and/or audio feedback and may also include haptic feedback provided by a haptic assembly, such as one or more haptic assemblies 1862 of haptic device 1800 (e.g., haptic assemblies 1862-1, 1862-2, 1862-3, etc.). For example, the haptic feedback may prevent (or, at a minimum, hinder/resist movement of) one or more fingers of a user from bending past a certain point to simulate the sensation of touching a solid coffee mug. In actuating such haptic effects, haptic device 1800 can change (either directly or indirectly) a pressurized state of one or more of haptic assemblies 1862.

Haptic system 1800 may optionally include other subsystems and components, such as touch-sensitive pads, pressure sensors, motion sensors, position sensors, lighting elements, and/or user interface elements (e.g., an on/off button, a vibration control element, etc.). During use, haptic assemblies 1862 may be configured to be activated for a variety of different reasons, such as in response to the user’s interaction with user interface elements, a signal from the motion or position sensors, a signal from the touch-sensitive pads, a signal from the pressure sensors, a signal from the other device or system, etc.

In FIGS. 18A and 18B, each of haptic assemblies 1862 may include a mechanism that, at a minimum, provides resistance when the respective haptic assembly 1862 is transitioned from a first pressurized state (e.g., atmospheric pressure or deflated) to a second pressurized state (e.g., inflated to a threshold pressure). Structures of haptic assemblies 1862 can be integrated into various devices configured to be in contact or proximity to a user’s skin, including, but not limited to devices such as glove worn devices, body worn clothing device, headset devices.

As noted above, haptic assemblies 1862 described herein can be configured to transition between a first pressurized state and a second pressurized state to provide haptic feedback to the user. Due to the ever-changing nature of artificial-reality, haptic assemblies 1862 may be required to transition between the two states hundreds, or perhaps thousands of times, during a single use. Thus, haptic assemblies 1862 described herein are durable and designed to quickly transition from state to state. To provide some context, in the first pressurized state, haptic assemblies 1862 do not impede free movement of a portion of the wearer’s body. For example, one or more haptic assemblies 1862 incorporated into a glove are made from flexible materials that do not impede free movement of the wearer’s hand and fingers (e.g., an electrostatic-zipping actuator). Haptic assemblies 1862 may be configured to conform to a shape of the portion of the wearer’s body when in the first pressurized state. However, once in the second pressurized state, haptic assemblies 1862 can be configured to restrict and/or impede free movement of the portion of the wearer’s body (e.g., appendages of the user’s hand). For example, the respective haptic assembly 1862 (or multiple respective haptic assemblies) can restrict movement of a wearer’s finger (e.g., prevent the finger from curling or extending) when haptic assembly 1862 is in the second pressurized state. Moreover, once in the second pressurized state, haptic assemblies 1862 may take different shapes, with some haptic assemblies 1862 configured to take a planar, rigid shape (e.g., flat and rigid), while some other haptic assemblies 1862 are configured to curve or bend, at least partially.

As a non-limiting example, haptic device 1800 includes a plurality of haptic devices (e.g., a pair of haptic gloves, a haptics component of a wrist-wearable device (e.g., any of the wrist-wearable devices described with respect to FIGS. 7-11), etc.), each of which can include a garment component (e.g., a garment 1804) and one or more haptic assemblies coupled (e.g., physically coupled) to the garment component. For example, each of the haptic assemblies 1862-1, 1862-2, 1862-3, . . . 1862-N are physically coupled to the garment 1804 and are configured to contact respective phalanges of a user’s thumb and fingers. As explained above, haptic assemblies 1862 are configured to provide haptic simulations to a wearer of device 1800. Garment 1804 of each device 1800 can be one of various articles of clothing (e.g., gloves, socks, shirts, pants, etc.). Thus, a user may wear multiple haptic devices 1800 that are each configured to provide haptic stimulations to respective parts of the body where haptic devices 1800 are being worn.

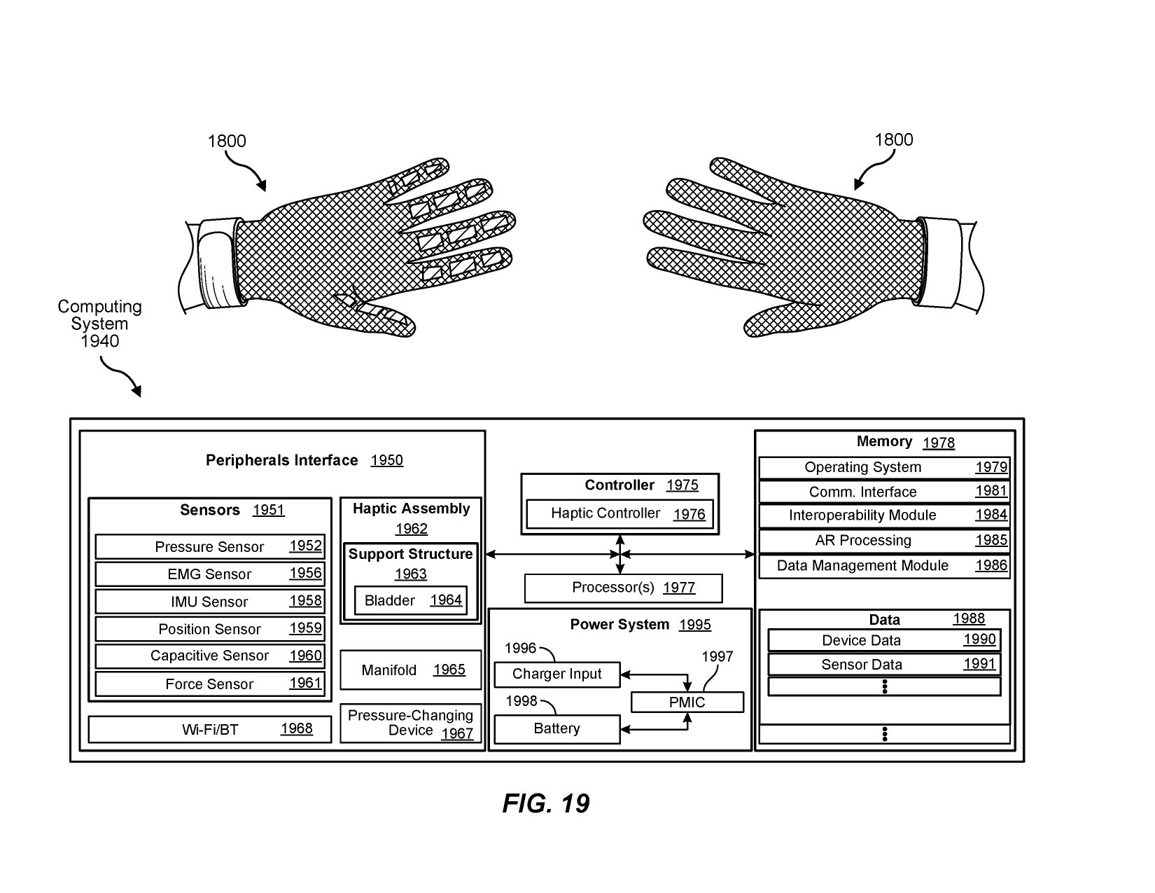

FIG. 19 shows block diagrams of a computing system 1940 of haptic device 1800, in accordance with some embodiments. Computing system 1940 can include one or more peripherals interfaces 1950, one or more power systems 1995, one or more controllers 1975 (including one or more haptic controllers 1976), one or more processors 1977 (as defined above, including any of the examples provided), and memory 1978, which can all be in electronic communication with each other. For example, one or more processors 1977 can be configured to execute instructions stored in the memory 1978, which can cause a controller of the one or more controllers 1975 to cause operations to be performed at one or more peripheral devices of peripherals interface 1950. In some embodiments, each operation described can occur based on electrical power provided by the power system 1995. The power system 1995 can include a charger input 1996, a PMIC 1997, and a battery 1998.

In some embodiments, peripherals interface 1950 can include one or more devices configured to be part of computing system 1940, many of which have been defined above and/or described with respect to wrist-wearable devices shown in FIGS. 11 and 12. For example, peripherals interface 1950 can include one or more sensors 1951. Some example sensors include: one or more pressure sensors 1952, one or more EMG sensors 1956, one or more IMU sensors 1958, one or more position sensors 1959, one or more capacitive sensors 1960, one or more force sensors 1961; and/or any other types of sensors defined above or described with respect to any other embodiments discussed herein.

In some embodiments, the peripherals interface can include one or more additional peripheral devices, including one or more Wi-Fi and/or Bluetooth devices 1968; one or more haptic assemblies 1962; one or more support structures 1963 (which can include one or more bladders 1964; one or more manifolds 1965; one or more pressure-changing devices 1967; and/or any other types of peripheral devices defined above or described with respect to any other embodiments discussed herein.

In some embodiments, each haptic assembly 1962 includes a support structure 1963 and at least one bladder 1964. Bladder 1964 (e.g., a membrane) may be a sealed, inflatable pocket made from a durable and puncture-resistant material, such as thermoplastic polyurethane (TPU), a flexible polymer, or the like. Bladder 1964 contains a medium (e.g., a fluid such as air, inert gas, or even a liquid) that can be added to or removed from bladder 1964 to change a pressure (e.g., fluid pressure) inside the bladder 1964. Support structure 1963 is made from a material that is stronger and stiffer than the material of bladder 1964. A respective support structure 1963 coupled to a respective bladder 1964 is configured to reinforce the respective bladder 1964 as the respective bladder 1964 changes shape and size due to changes in pressure (e.g., fluid pressure) inside the bladder.

The system 1940 also includes a haptic controller 1976 and a pressure-changing device 1967. In some embodiments, haptic controller 1976 is part of the computer system 1940 (e.g., in electronic communication with one or more processors 1977 of the computer system 1940). Haptic controller 1976 is configured to control operation of pressure-changing device 1967, and in turn operation of haptic device 1800. For example, haptic controller 1976 sends one or more signals to pressure-changing device 1967 to activate pressure-changing device 1967 (e.g., turn it on and off). The one or more signals may specify a desired pressure (e.g., pounds-per-square inch) to be output by pressure-changing device 1967. Generation of the one or more signals, and in turn the pressure output by pressure-changing device 1967, may be based on information collected by sensors 1951. For example, the one or more signals may cause pressure-changing device 1967 to increase the pressure (e.g., fluid pressure) inside a first haptic assembly 1962 at a first time, based on the information collected by sensors 1951 (e.g., the user makes contact with an artificial coffee mug or other artificial object). Then, the controller may send one or more additional signals to pressure-changing device 1967 that cause pressure-changing device 1967 to further increase the pressure inside first haptic assembly 1962 at a second time after the first time, based on additional information collected by sensors 1951. Further, the one or more signals may cause pressure-changing device 1967 to inflate one or more bladders 1964 in a first device 1800A, while one or more bladders 1964 in a second device 1800B remain unchanged. Additionally, the one or more signals may cause pressure-changing device 1967 to inflate one or more bladders 1964 in a first device 1800A to a first pressure and inflate one or more other bladders 1964 in first device 1800A to a second pressure different from the first pressure. Depending on number of haptic devices 1800 serviced by pressure-changing device 1967, and the number of bladders therein, many different inflation configurations can be achieved through the one or more signals and the examples above are not meant to be limiting.

The system 1940 may include an optional manifold 1965 between pressure-changing device 1967 and haptic devices 1800. Manifold 1965 may include one or more valves (not shown) that pneumatically couple each of haptic assemblies 1962 with pressure-changing device 1967 via tubing. In some embodiments, manifold 1965 is in communication with controller 1975, and controller 1975 controls the one or more valves of manifold 1965 (e.g., the controller generates one or more control signals). Manifold 1965 is configured to switchably couple pressure-changing device 1967 with one or more haptic assemblies 1962 of the same or different haptic devices 1800 based on one or more control signals from controller 1975. In some embodiments, instead of using manifold 1965 to pneumatically couple pressure-changing device 1967 with haptic assemblies 1962, system 1940 may include multiple pressure-changing devices 1967, where each pressure-changing device 1967 is pneumatically coupled directly with a single haptic assembly 1962 or multiple haptic assemblies 1962. In some embodiments, pressure-changing device 1967 and optional manifold 1965 can be configured as part of one or more of the haptic devices 1800 while, in other embodiments, pressure-changing device 1967 and optional manifold 1965 can be configured as external to haptic device 1800. A single pressure-changing device 1967 may be shared by multiple haptic devices 1800.

In some embodiments, pressure-changing device 1967 is a pneumatic device, hydraulic device, a pneudraulic device, or some other device capable of adding and removing a medium (e.g., fluid, liquid, gas) from the one or more haptic assemblies 1962.

The devices shown in FIGS. 18A-19 may be coupled via a wired connection (e.g., via busing). Alternatively, one or more of the devices shown in FIGS. 18A-19 may be wirelessly connected (e.g., via short-range communication signals).

Memory 1978 includes instructions and data, some or all of which may be stored as non-transitory computer-readable storage media within memory 1978. For example, memory 1978 can include one or more operating systems 1979; one or more communication interface applications 1981; one or more interoperability modules 1984; one or more AR processing applications 1985; one or more data management modules 1986; and/or any other types of applications or modules defined above or described with respect to any other embodiments discussed herein.

Memory 1978 also includes data 1988 which can be used in conjunction with one or more of the applications discussed above. Data 1988 can include: device data 1990; sensor data 1991; and/or any other types of data defined above or described with respect to any other embodiments discussed herein.

In some embodiments, the systems described herein may also include an eye-tracking subsystem designed to identify and track various characteristics of a user’s eye(s), such as the user’s gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user’s eye(s).

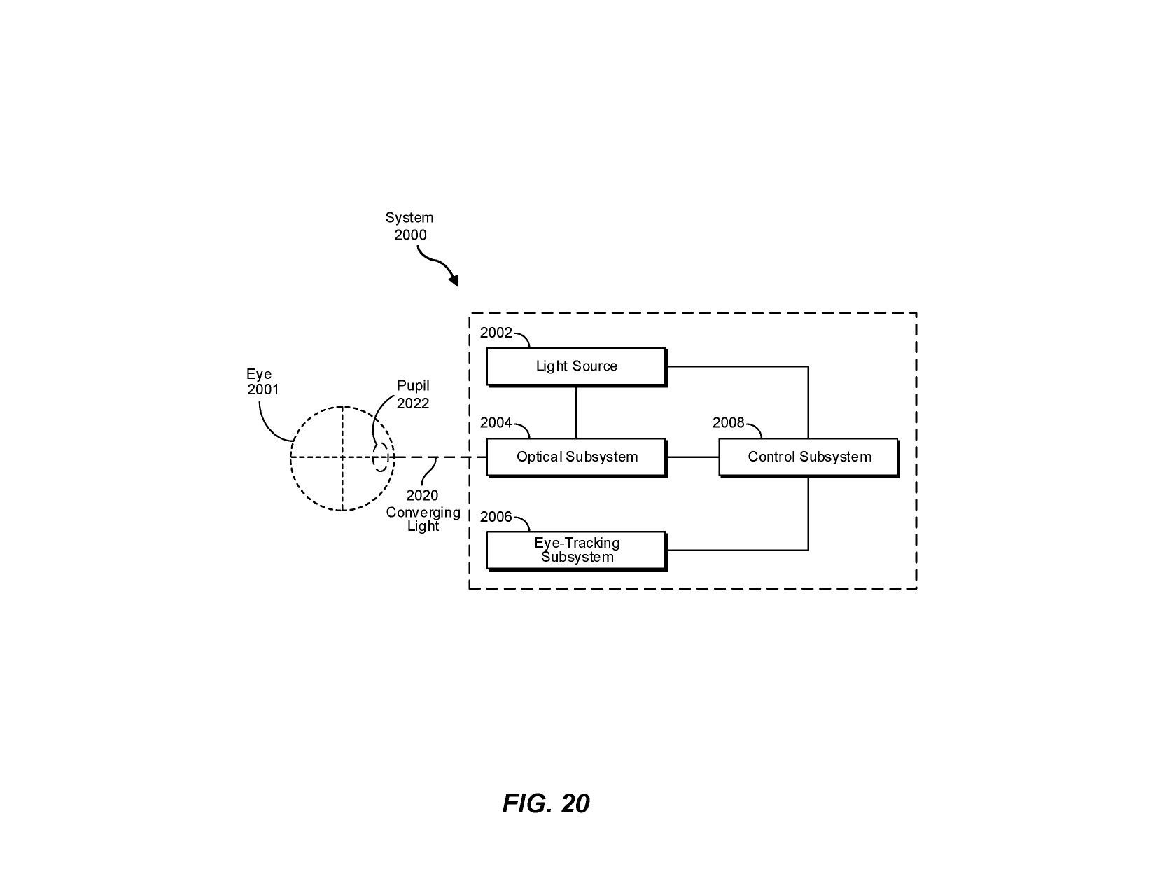

FIG. 20 is an illustration of an example system 2000 that incorporates an eye-tracking subsystem capable of tracking a user’s eye(s). As depicted in FIG. 20, system 2000 may include a light source 2002, an optical subsystem 2004, an eye-tracking subsystem 2006, and/or a control subsystem 2008. In some examples, light source 2002 may generate light for an image (e.g., to be presented to an eye 2001 of the viewer). Light source 2002 may represent any of a variety of suitable devices. For example, light source 2002 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray’s actual divergence.

In some embodiments, optical subsystem 2004 may receive the light generated by light source 2002 and generate, based on the received light, converging light 2020 that includes the image. In some examples, optical subsystem 2004 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 2020. Further, various mechanical couplings may serve to maintain the relative spacing and/or the orientation of the optical components in any suitable combination.

In one embodiment, eye-tracking subsystem 2006 may generate tracking information indicating a gaze angle of an eye 2001 of the viewer. In this embodiment, control subsystem 2008 may control aspects of optical subsystem 2004 (e.g., the angle of incidence of converging light 2020) based at least in part on this tracking information. Additionally, in some examples, control subsystem 2008 may store and utilize historical tracking information (e.g., a history of the tracking information over a given duration, such as the previous second or fraction thereof) to anticipate the gaze angle of eye 2001 (e.g., an angle between the visual axis and the anatomical axis of eye 2001). In some embodiments, eye-tracking subsystem 2006 may detect radiation emanating from some portion of eye 2001 (e.g., the cornea, the iris, the pupil, or the like) to determine the current gaze angle of eye 2001. In other examples, eye-tracking subsystem 2006 may employ a wavefront sensor to track the current location of the pupil.

Any number of techniques can be used to track eye 2001. Some techniques may involve illuminating eye 2001 with infrared light and measuring reflections with at least one optical sensor that is tuned to be sensitive to the infrared light. Information about how the infrared light is reflected from eye 2001 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 2006 may be digitized (i.e., converted to an electronic signal). Further, the sensor may transmit a digital representation of this electronic signal to one or more processors (for example, processors associated with a device including eye-tracking subsystem 2006). Eye-tracking subsystem 2006 may include any of a variety of sensors in a variety of different configurations. For example, eye-tracking subsystem 2006 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 2006 to track the movement of eye 2001. In another example, these processors may track the movements of eye 2001 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 2006 may be programmed to use an output of the sensor(s) to track movement of eye 2001. In some embodiments, eye-tracking subsystem 2006 may analyze the digital representation generated by the sensors to extract eye rotation information from changes in reflections. In one embodiment, eye-tracking subsystem 2006 may use corneal reflections or glints (also known as Purkinje images) and/or the center of the eye’s pupil 2022 as features to track over time.

In some embodiments, eye-tracking subsystem 2006 may use the center of the eye’s pupil 2022 and infrared or near-infrared, non-collimated light to create corneal reflections. In these embodiments, eye-tracking subsystem 2006 may use the vector between the center of the eye’s pupil 2022 and the corneal reflections to compute the gaze direction of eye 2001. In some embodiments, the disclosed systems may perform a calibration procedure for an individual (using, e.g., supervised or unsupervised techniques) before tracking the user’s eyes. For example, the calibration procedure may include directing users to look at one or more points displayed on a display while the eye-tracking system records the values that correspond to each gaze position associated with each point.

In some embodiments, eye-tracking subsystem 2006 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 2001 may act as a retroreflector as the light reflects off the retina, thereby creating a bright pupil effect similar to a red-eye effect in photography. If the illumination source is offset from the optical path, then the eye’s pupil 2022 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 2008 may control light source 2002 and/or optical subsystem 2004 to reduce optical aberrations (e.g., chromatic aberrations and/or monochromatic aberrations) of the image that may be caused by or influenced by eye 2001. In some examples, as mentioned above, control subsystem 2008 may use the tracking information from eye-tracking subsystem 2006 to perform such control. For example, in controlling light source 2002, control subsystem 2008 may alter the light generated by light source 2002 (e.g., by way of image rendering) to modify (e.g., pre-distort) the image so that the aberration of the image caused by eye 2001 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user’s eye may necessitate modification of a corresponding eye-tracking algorithm. For example, eye-tracking algorithms may need to be modified based at least in part on the differing color contrast between a brown eye and, for example, a blue eye.

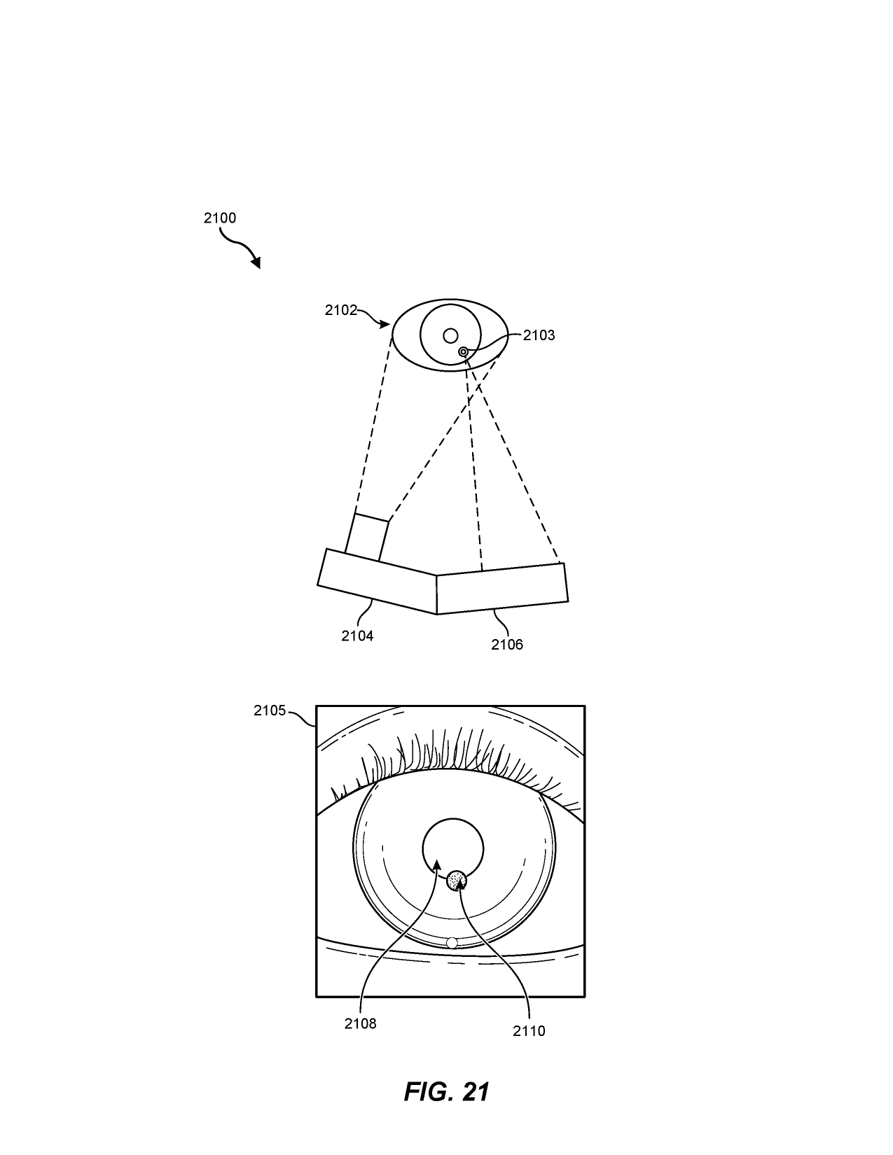

FIG. 21 is a more detailed illustration of various aspects of the eye-tracking subsystem illustrated in FIG. 20. As shown in this figure, an eye-tracking subsystem 2100 may include at least one source 2104 and at least one sensor 2106. Source 2104 generally represents any type or form of element capable of emitting radiation. In one example, source 2104 may generate visible, infrared, and/or near-infrared radiation. In some examples, source 2104 may radiate non-collimated infrared and/or near-infrared portions of the electromagnetic spectrum towards an eye 2102 of a user. Source 2104 may utilize a variety of sampling rates and speeds. For example, the disclosed systems may use sources with higher sampling rates in order to capture fixational eye movements of a user’s eye 2102 and/or to correctly measure saccade dynamics of the user’s eye 2102. As noted above, any type or form of eye-tracking technique may be used to track the user’s eye 2102, including optical-based eye-tracking techniques, ultrasound-based eye-tracking techniques, etc.

Sensor 2106 generally represents any type or form of element capable of detecting radiation, such as radiation reflected off the user’s eye 2102. Examples of sensor 2106 include, without limitation, a charge coupled device (CCD), a photodiode array, a complementary metal-oxide-semiconductor (CMOS) based sensor device, and/or the like. In one example, sensor 2106 may represent a sensor having predetermined parameters, including, but not limited to, a dynamic resolution range, linearity, and/or other characteristic selected and/or designed specifically for eye tracking.

As detailed above, eye-tracking subsystem 2100 may generate one or more glints. As detailed above, a glint 2103 may represent reflections of radiation (e.g., infrared radiation from an infrared source, such as source 2104) from the structure of the user’s eye. In various embodiments, glint 2103 and/or the user’s pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 21 shows an example image 2105 captured by an eye-tracking subsystem, such as eye-tracking subsystem 2100. In this example, image 2105 may include both the user’s pupil 2108 and a glint 2110 near the same. In some examples, pupil 2108 and/or glint 2110 may be identified using an artificial-intelligence-based algorithm, such as a computer-vision-based algorithm. In one embodiment, image 2105 may represent a single frame in a series of frames that may be analyzed continuously in order to track the eye 2102 of the user. Further, pupil 2108 and/or glint 2110 may be tracked over a period of time to determine a user’s gaze.

In one example, eye-tracking subsystem 2100 may be configured to identify and measure the inter-pupillary distance (IPD) of a user. In some embodiments, eye-tracking subsystem 2100 may measure and/or calculate the IPD of the user while the user is wearing the artificial reality system. In these embodiments, eye-tracking subsystem 2100 may detect the positions of a user’s eyes and may use this information to calculate the user’s IPD.

As noted, the eye-tracking systems or subsystems disclosed herein may track a user’s eye position and/or eye movement in a variety of ways. In one example, one or more light sources and/or optical sensors may capture an image of the user’s eyes. The eye-tracking subsystem may then use the captured information to determine the user’s inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user’s pupil and a display may change as the user’s eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user’s eyes and applying a distortion correction corresponding to the 3D position of each of the user’s eyes at a given point in time. Thus, knowing the 3D position of each of a user’s eyes may allow for the mitigation of distortion caused by changes in the distance between the pupil of the eye and the display by applying a distortion correction for each 3D eye position. Furthermore, as noted above, knowing the position of each of the user’s eyes may also enable the eye-tracking subsystem to make automated adjustments for a user’s IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user’s gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user’s eyes are verged is where the user is looking and is also typically the location where the user’s eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user’s eyes are directed. Thus, the vergence distance may allow for the determination of a location where the user’s eyes should be focused and a depth from the user’s eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user’s vergence depth. When the user is focused on something at a distance, the user’s pupils may be slightly farther apart than when the user is focused on something close. The eye-tracking subsystem may obtain information about the user’s vergence or focus depth and may adjust the display subsystem to be closer together when the user’s eyes focus or verge on something close and to be farther apart when the user’s eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user’s eye movement, such that if a user is looking up, the computer-generated images may be moved upward on the screen. Similarly, if the user is looking to the side or down, the computer-generated images may be moved to the side or downward on the screen. If the user’s eyes are closed, the computer-generated images may be paused or removed from the display and resumed once the user’s eyes are back open.

The above-described eye-tracking subsystems can be incorporated into one or more of the various artificial reality systems described herein in a variety of ways. For example, one or more of the various components of system 2000 and/or eye-tracking subsystem 2100 may be incorporated into any of the augmented-reality systems in and/or virtual-reality systems described herein in to enable these systems to perform various eye-tracking tasks (including one or more of the eye-tracking operations described herein).

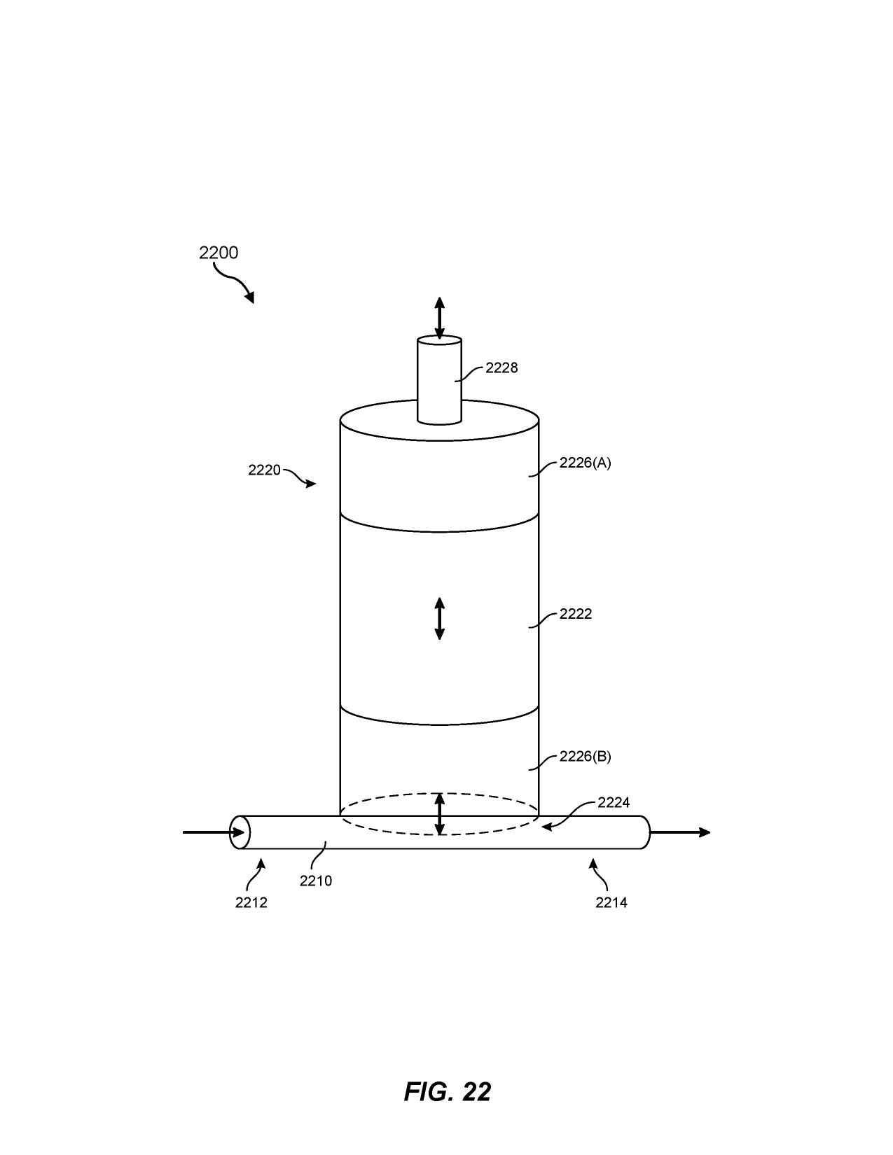

As noted above, the present disclosure may also include haptic fluidic systems that involve the control (e.g., stopping, starting, restricting, increasing, etc.) of fluid flow through a fluid channel. The control of fluid flow may be accomplished with a fluidic valve. FIG. 22 shows a schematic diagram of a fluidic valve 2200 for controlling flow through a fluid channel 2210, according to at least one embodiment of the present disclosure. Fluid from a fluid source (e.g., a pressurized fluid source, a fluid pump, etc.) may flow through the fluid channel 2210 from an inlet port 2212 to an outlet port 2214, which may be operably coupled to, for example, a fluid-driven mechanism, another fluid channel, or a fluid reservoir.

Fluidic valve 2200 may include a gate 2220 for controlling the fluid flow through fluid channel 2210. Gate 2220 may include a gate transmission element 2222, which may be a movable component that is configured to transmit an input force, pressure, or displacement to a restricting region 2224 to restrict or stop flow through the fluid channel 2210. Conversely, in some examples, application of a force, pressure, or displacement to gate transmission element 2222 may result in opening restricting region 2224 to allow or increase flow through the fluid channel 2210. The force, pressure, or displacement applied to gate transmission element 2222 may be referred to as a gate force, gate pressure, or gate displacement. Gate transmission element 2222 may be a flexible element (e.g., an elastomeric membrane, a diaphragm, etc.), a rigid element (e.g., a movable piston, a lever, etc.), or a combination thereof (e.g., a movable piston or a lever coupled to an elastomeric membrane or diaphragm).

As illustrated in FIG. 22, gate 2220 of fluidic valve 2200 may include one or more gate terminals, such as an input gate terminal 2226(A) and an output gate terminal 2226(B) (collectively referred to herein as “gate terminals 2226”) on opposing sides of gate transmission element 2222. Gate terminals 2226 may be elements for applying a force (e.g., pressure) to gate transmission element 2222. By way of example, gate terminals 2226 may each be or include a fluid chamber adjacent to gate transmission element 2222. Alternatively or additionally, one or more of gate terminals 2226 may include a solid component, such as a lever, screw, or piston, that is configured to apply a force to gate transmission element 2222.

In some examples, a gate port 2228 may be in fluid communication with input gate terminal 2226(A) for applying a positive or negative fluid pressure within the input gate terminal 2226(A). A control fluid source (e.g., a pressurized fluid source, a fluid pump, etc.) may be in fluid communication with gate port 2228 to selectively pressurize and/or depressurize input gate terminal 2226(A). In additional embodiments, a force or pressure may be applied at the input gate terminal 2226(A) in other ways, such as with a piezoelectric element or an electromechanical actuator, etc.

In the embodiment illustrated in FIG. 22, pressurization of the input gate terminal 2226(A) may cause the gate transmission element 2222 to be displaced toward restricting region 2224, resulting in a corresponding pressurization of output gate terminal 2226(B). Pressurization of output gate terminal 2226(B) may, in turn, cause restricting region 2224 to partially or fully restrict to reduce or stop fluid flow through the fluid channel 2210. Depressurization of input gate terminal 2226(A) may cause gate transmission element 2222 to be displaced away from restricting region 2224, resulting in a corresponding depressurization of the output gate terminal 2226(B). Depressurization of output gate terminal 2226(B) may, in turn, cause restricting region 2224 to partially or fully expand to allow or increase fluid flow through fluid channel 2210. Thus, gate 2220 of fluidic valve 2200 may be used to control fluid flow from inlet port 2212 to outlet port 2214 of fluid channel 2210.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
at least one input grating and at least one output grating disposed over a first surface of a waveguide;
at least one active component and corresponding circuitry bonded to the first surface of the waveguide; and
at least one lens, mounted to a support structure, that encapsulates both the first surface of the waveguide and a second surface of the waveguide.

2. The device of claim 1, wherein the first surface of the waveguide is sequentially patterned to form the at least one input grating and the at least one output grating and metallized to bond the at least one active component and corresponding circuitry to the first surface of the patterned waveguide.

3. The device of claim 1, wherein the first surface of the waveguide is spaced apart from the second surface of the waveguide by a thickness of the waveguide.

4. The device of claim 1, wherein the at least one active component and corresponding circuitry comprise conductive traces positioned away from the at least one input grating and the at least one output grating.

5. The device of claim 4, wherein the conductive traces are configured to connect the at least one active component to an off-lens driver board.

6. The device of claim 4, wherein the conductive traces comprise a material selected from the group consisting of metals and non-metals.

7. The device of claim 1, further comprising an optical dimming layer disposed over the second surface of the waveguide.

8. The device of claim 7, wherein the optical dimming layer comprises at least one electrochromic dye configured to provide active dimming.

9. The device of claim 7, wherein the optical dimming layer comprises at least one photochromatic material configured to provide passive dimming.

10. The device of claim 1, wherein the at least one lens comprises a material selected from the group consisting of meth(acrylics), polyurethane, epoxy and other high index polymers.

11. A method comprising:
patterning a first surface of a waveguide to form at least one input grating and at least one output grating;
metalizing the first surface of the patterned waveguide to module bond at least one active component and corresponding circuitry to the first surface of the patterned waveguide; and
applying a lens material to encapsulate both the first surface of the patterned and metalized waveguide and a second surface of the waveguide.

12. The method of claim 11, wherein patterning and metalizing the first surface of the waveguide is performed sequentially on a single production line.

13. The method of claim 11, wherein the first surface of the waveguide is spaced apart from the second surface of the waveguide by a thickness of the waveguide.

14. The method of claim 11, wherein the at least one active component and corresponding circuitry are positioned away from the at least one input grating and the at least one output grating.

15. The method of claim 11, further comprising disposing an optical dimming layer over a second surface of the waveguide.

16. The method of claim 15, wherein the optical dimming layer comprises at least one electrochromic dye configured to provide active dimming.

17. The method of claim 15, wherein the optical dimming layer comprises at least one photochromatic material configured to provide passive dimming.

18. The method of claim 11, further comprising applying the lens material uniformly to cover the first surface of the waveguide and a second surface of the waveguide the waveguide.

19. A method comprising:
patterning a first surface of a plurality of regions of a wafer material to form at least one input grating and at least one output grating;
metallizing the first surface of the plurality of patterned regions of the wafer material to module bond at least one active component and corresponding circuitry to the first surface of the plurality of patterned regions of the wafer material;
separating the first surface of the plurality of patterned and metalized regions of the wafer material; and
applying a lens material to encapsulate the first surface of the plurality of patterned and metalized regions of the wafer material and a second surface of the wafer material.

20. The method of claim 19, wherein a diameter of the wafer material is selected from the group consisting of 6 inches, 8 inches, and 12 inches.
